(19) United States
(12) Patent Application Publication
(10) Pub. No.: US 2025/0309719 A1
(43) Pub. Date: Oct. 2, 2025

(54) COIL ASSEMBLY, ARMATURE AND ROTATING ELECTRIC MACHINE

(71) Applicant: DENSO CORPORATION, Kariya-city (JP)

(72) Inventors: Yusuke TATEISHI, Kariya-city (JP); Shinji Makita, Kariya-city (JP); Keisuke Koide, Kariya-city (JP); Yuji Hayashi, Kariya-city (JP)

(73) Assignee: DENSO CORPORATION, Kariya-city (JP)

(21) Appl. No.: 19/232,361

(22) Filed: Jun. 9, 2025

Related U.S. Application Data
(63) Continuation of application No. PCT/JP2023/036636, filed on Oct. 6, 2023.

(30) Foreign Application Priority Data
Dec. 12, 2022 (JP) 2022-198067

(51) Int. Cl. H02K 3/28

(52) U.S. Cl. CPC H02K 3/28; H02K 2203/09

(57) ABSTRACT

A coil assembly includes band members and a plurality of coil units. The band members are formed of an electrically-insulative material into a sheet shape extending in a circumferential direction, and are laminated in layers in a radial direction. The coil units are formed of an electroconductive material on each of the band members, and have a plurality of electrical conductor portions arranged in alignment with one another along the circumferential direction. The electrical conductor portions formed on the band member of a first layer and the electrical conductor portions formed on the band member of a second layer are arranged alternately along the circumferential direction. Moreover, the electrical conductor portions formed on the band member of the first layer and the electrical conductor portions formed on the band member of the second layer overlap one another in the circumferential direction.

### CROSS-REFERENCE TO RELATED APPLICATIONS

The present application is a continuation application of International Application No. PCT/JP2023/036636 filed on Oct. 6, 2023, which is based on and claims priority from Japanese Patent Application No. 2022-198067, filed on Dec. 12, 2022. The entire contents of these applications are incorporated by reference into the present application.

### BACKGROUND

### 1 Technical Field

The present disclosure relates to coil assemblies, armatures and rotating electric machines.

### 2 Description of Related Art

There is known a cylindrical coil as disclosed, for example, in Japanese Patent No. JP 5017627 B2. The cylindrical coil has a coil pattern that is formed on a cylindrical substate by: forming a coil pattern groove in an outer surface of the cylindrical substate; and filling the coil pattern groove with an electroconductive material. With this configuration, it is possible to improve the accuracy of roundness and runout of the cylindrical coil. Moreover, in a rotating electric machine that includes the cylindrical coil, it is possible to reduce a magnetic gap, thereby enabling improvement in the output and efficiency of the rotating electric machine.

### SUMMARY

In terms of achieving high efficiency and high torque of a rotating electric machine, it is desirable to improve the space factor of the coil assembly (or cylindrical coil) employed in the rotating electric machine. In this regard, there is room for improvement in the configuration of the known coil assembly described above.

The present disclosure has been accomplished in view of the above problem.

According to a first aspect of the present disclosure, there is provided a coil assembly which includes: sheet-shaped members formed of an electrically-insulative material into a sheet shape extending in a circumferential direction, the sheet-shaped members being laminated in layers in a radial direction; and a plurality of coil units formed of an electroconductive material on each of the sheet-shaped members and having a plurality of electrical conductor portions arranged in alignment with one another along the circumferential direction, wherein the electrical conductor portions formed on the sheet-shaped member of a first layer and the electrical conductor portions formed on the sheet-shaped member of a second layer are arranged alternately along the circumferential direction, and the electrical conductor portions formed on the sheet-shaped member of the first layer and the electrical conductor portions formed on the sheet-shaped member of the second layer overlap one another in the circumferential direction. Moreover, according to a second aspect of the present disclosure, there is provided an armature which includes the coil assembly provided according to the first aspect of the present disclosure. Furthermore, according to a third aspect of the present disclosure, there is provided a rotating electric machine which includes a stator and a rotor, wherein one of the stator and the rotor includes the armature provided according to the second aspect of the present disclosure, and the other of the stator and the rotor has a magnet arranged to face the coil assembly in the radial direction or in an axial direction.

With the above configuration, it becomes possible to improve the space factor of the coil assembly.

### BRIEF DESCRIPTION OF THE DRAWINGS

FIG. 1 is a perspective view showing a motor, with part of the motor cut away.

FIG. 2 is an exploded perspective view showing the motor in a disassembled state, with parts of some components thereof cut way.

FIG. 3 is a schematic perspective view of a coil assembly.

FIG. 4 is a diagram showing the coil assembly.

FIG. 5 is a diagram illustrating a star connection.

FIG. 6 is a diagram showing a coil unit.

FIG. 7 is a diagram showing a coil unit whose configuration is different from that of the coil unit shown in FIG. 6.

FIG. 8 is a diagram showing a plurality of U-phase coil units.

FIG. 9 is a schematic diagram showing a plurality of coil units constituting a first U-phase coil group and a plurality of coil units constituting a second U-phase coil group, with the first and second U-phase coil groups offset from each other in an axial direction.

FIG. 10 is a cross-sectional view of a part of the coil assembly.

FIG. 11 is a cross-sectional view of another part of the coil assembly.

FIG. 12 is a cross-sectional view of yet another part of the coil assembly.

FIG. 13 is a cross-sectional view of the coil assembly taken along a radial direction.

FIG. 14 is a cross-sectional view of a part of a band member of a specific layer and coil units formed on the part of the band member in a coil assembly of a motor according to a first embodiment.

FIG. 15 is a cross-sectional view of parts of band members of a plurality of layers and coil units formed on the parts of the band members in the coil assembly of the motor according to the first embodiment.

FIG. 16 is a schematic perspective view illustrating a step of overlapping the band member of a first layer and the band member of a second layer in a manufacturing process of the coil assembly of the motor according to the first embodiment.

FIG. 17 is a planar development of both the band member of the first layer and the band member of the second layer which is radially adjacent to the band member of the first layer in the coil assembly of the motor according to the first embodiment.

FIG. 18 is a diagram showing the overlapped state of the band member of the first layer and the band member of the second layer both of which are shown in FIG. 17.

FIG. 19 is a cross-sectional view of a part of a band member of a specific layer and coil units formed on the part of the band member in a coil assembly of a motor according to a second embodiment.

FIG. 20 is a cross-sectional view of parts of band members of a plurality of layers and coil units formed on the parts of the band members in the coil assembly of the motor according to the second embodiment.

FIG. 21 is a schematic perspective view illustrating a step of overlapping the band member of a first layer and the band member of a second layer in a manufacturing process of the coil assembly of the motor according to the second embodiment.

FIG. 22 is a planar development of both the band member of the first layer and the band member of the second layer which is radially adjacent to the band member of the first layer in the coil assembly of the motor according to the second embodiment.

FIG. 23 is a diagram showing the overlapped state of the band member of the first layer and the band member of the second layer both of which are shown in FIG. 22.

FIG. 24 is a schematic cross-sectional view, taken along a radial direction, of a stator of a motor according to a third embodiment.

FIG. 25 is a schematic cross-sectional view, taken along a radial direction, of a stator of a motor according to a fourth embodiment.

FIG. 26 is a schematic cross-sectional view, taken along a radial direction, of a stator of a motor according to a fifth embodiment.

FIG. 27 is a schematic cross-sectional view, taken along a radial direction, of part of a motor according to a sixth embodiment.

FIG. 28 is a schematic cross-sectional view, taken along a radial direction, of part of a motor according to a seventh embodiment.

FIG. 29 is a schematic cross-sectional view, taken along a radial direction, of part of a motor according to an eighth embodiment.

FIG. 30 is a planar development of both a band member of a first layer and a band member of a second layer which is radially adjacent to the band member of the first layer in a coil assembly of a motor according to a ninth embodiment.

FIG. 31 is a diagram showing the overlapped state of the band member of the first layer and the band member of the second layer both of which are shown in FIG. 30.

FIG. 32 is a diagram for explaining the manner of joining two circumferential end parts of a band member in a coil assembly of a motor according to a tenth embodiment.

FIG. 33 is a diagram for explaining the manner of joining two circumferential end parts of a band member in a coil assembly of a motor according to an eleventh embodiment.

FIG. 34 is a schematic cross-sectional view of a band member of a first layer, which has not been rolled into an annular shape, and coil units formed on the band member.

FIG. 35 is a diagram for explaining a process of rolling band members around a rolling mandrel.

FIG. 36 is a schematic cross-sectional view of a band member of a first layer, which has not been rolled into an annular shape, and coil units formed on the band member.

FIG. 37 is a diagram for explaining a process of rolling band members around a rolling mandrel.

FIG. 38 is a diagram for explaining a process of rolling band members around a rolling mandrel.

FIG. 39 is a diagram for explaining a process of rolling band members along a stator core.

FIG. 40 is a schematic diagram showing a cross section, taken along a radial direction, of a coil assembly of a motor according to a twelfth embodiment.

FIG. 41 is a schematic diagram showing a cross section, taken along a radial direction, of a coil assembly of a motor according to a thirteenth embodiment.

FIG. 42 is a schematic diagram showing a cross section, taken along a radial direction, of a coil assembly of a motor according to a fourteenth embodiment.

FIG. 43 is a schematic diagram showing a cross section, taken along a radial direction, of a coil assembly of a motor according to a fifteenth embodiment.

FIG. 44 is a schematic diagram showing a cross section, taken along a radial direction, of a coil assembly of a motor according to a sixteenth embodiment.

FIG. 45 is a schematic diagram showing a cross section, taken along a radial direction, of a coil assembly of a motor according to a seventeenth embodiment.

### DESCRIPTION OF EMBODIMENTS

### Basic Configuration of Motor

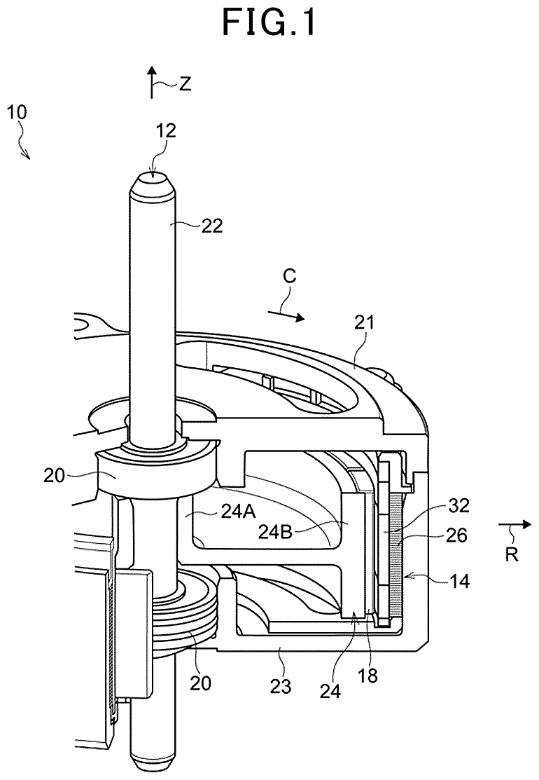

The basic configuration of a motor 10 according to the present disclosure will be described with reference to FIGS. 1 to 13. It should be noted that the arrows Z, R and C suitably shown in the drawings respectively indicate a first side in a rotation axial direction, the outer side in a rotation radial direction and a first side in a rotation circumferential direction of a rotor 12 that will be described later. Moreover, in the case of merely indicating the axial direction, the radial direction and the circumferential direction, unless specified otherwise, the arrows Z, R and C respectively indicate the rotation axial direction, the rotation radial direction and the rotation circumferential direction of the rotor 12. In addition, the motor 10 and motors according to embodiments to be described later are examples of rotating electric machines.

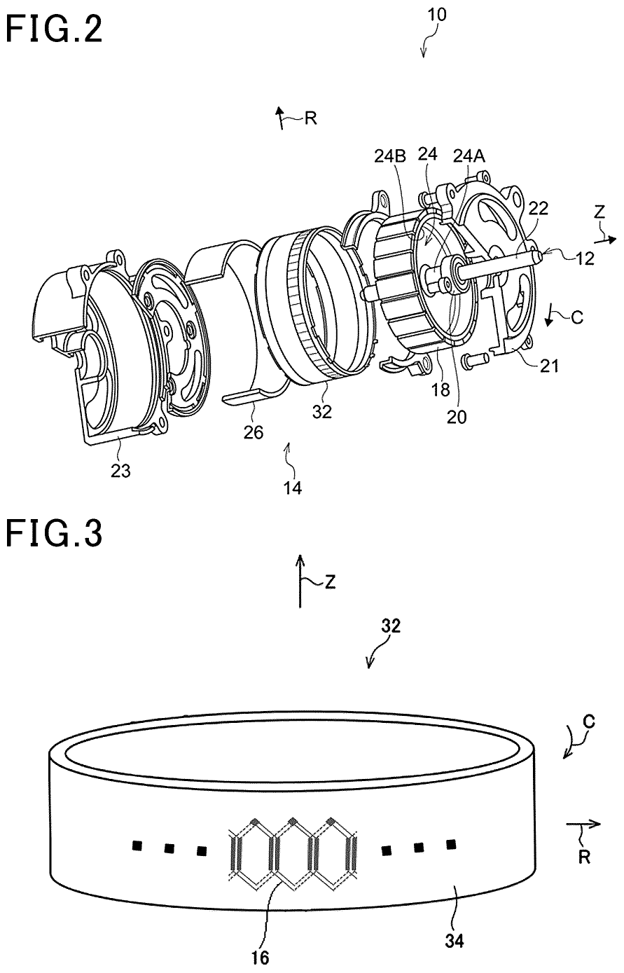

As shown in FIGS. 1 and 2, the motor 10 is configured as an inner rotor type brushless motor in which the rotor 12 is arranged radially inside a stator 14 that serves as an armature. It should be noted that: FIGS. 1 and 2 illustrate the motor 10 merely as an example; and there may be some inconsistencies in the number of coil units 16, the number of magnets 18 and the shapes of details between these figures and the later explanation of the motor 10.

The rotor 12 includes a rotating shaft 22 that is rotatably supported by a pair of bearings 20, a rotor core 24 fixed to the rotating shaft 22, and a plurality of magnets 18 fixed to a radially outer surface of the rotor core 24. The pair of bearings 20 are supported respectively by a frame 21 and a frame end 23. The stator 14 and other components are accommodated between the frame 21 and the frame end 23.

The rotor core 24 has a first cylindrical part 24A to which the rotating shaft 22 is fixed by press fitting or the like, and a second cylindrical part 24B arranged radially outside the first cylindrical part 24A. The second cylindrical part 24B has an outer circumferential surface, which constitutes the radially outer surface of the rotor core 24, formed along the circumferential direction into a cylindrical surface. The magnets 18, which will be described later, are fixed to the outer circumferential surface of the second cylindrical part 24B.

The magnets 18 are formed of a magnetic compound whose intrinsic coercive force Hc is higher than or equal to 400 [kA/m] and whose residual flux density Br is higher than or equal to 1.0 [T]. For example, the magnets 18 may be formed of a magnetic compound such as NdFe₁₁TiN, Nd₂Fe₁₄B, Sm₂Fe₁₇N₃ or FeNi. Moreover, as mentioned above, the magnets 18 are fixed to the outer circumferential surface of the second cylindrical part 24B of the rotor core 24. Furthermore, those magnets 18 each of which has a radially outer surface forming an N pole and those magnets 18 each of which has a radially outer surface forming an S pole are arranged alternately in the circumferential direction. In addition, the number of the magnets 18 may be suitably set in consideration of the output and the like required of the motor 10.

The stator 14 includes an annular stator core 26 that serves as an armature core, and a coil assembly 32 mounted to the stator core 26. As shown in FIGS. 1 to 3, the stator 14 has a toothless structure such that no part of the stator core 26 is arranged inside the coil units 16 each constituting a part of the coil assembly 32.

As shown in FIGS. 1 and 2, the stator core 26 is formed of a soft-magnetic material, such as steel, into an annular shape. The stator core 26 is arranged coaxially with the rotor 12; and the axial center position of the stator core 26 coincides in the axial direction with the axial center positions of the magnets 18 fixed to the rotor core 24.

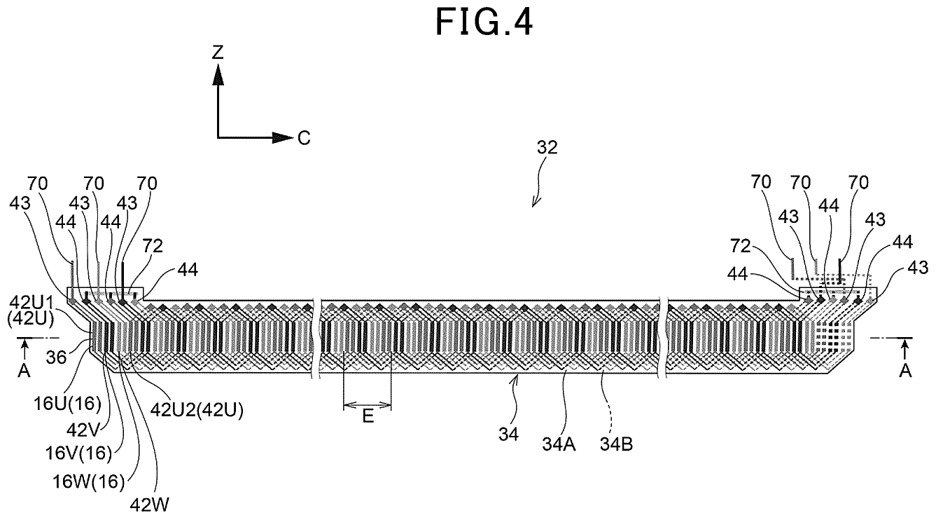

As shown in FIGS. 3 and 4, the coil assembly 32 includes a band member 34, which is a sheet-shaped member formed of an electrically-insulative material into a sheet shape, and the coil units 16 formed on the band member 34.

The band member 34 is formed in a band shape whose lateral direction coincides with the axial direction and whose longitudinal direction coincides with the circumferential perpendicular to the axial direction. Moreover, the thickness direction of the band member 34 coincides with the radial direction. The thickness of the band member 34 is set to such a thickness as to allow the band member 34 to be bent in the circumferential direction. The band member 34 is rolled along the circumferential direction a plurality of times into a cylindrical shape. In addition, most of the band member 34 has four layers in the radial direction. In this regard, detailed explanation will be given later.

As shown in FIG. 3, the coil units 16 are formed on the band member 34. Moreover, as shown in FIGS. 3 and 4, the band member 34 is rolled along the circumferential direction a plurality of times so that the coil units 16 are located at predetermined positions in the circumferential direction and the radial direction.

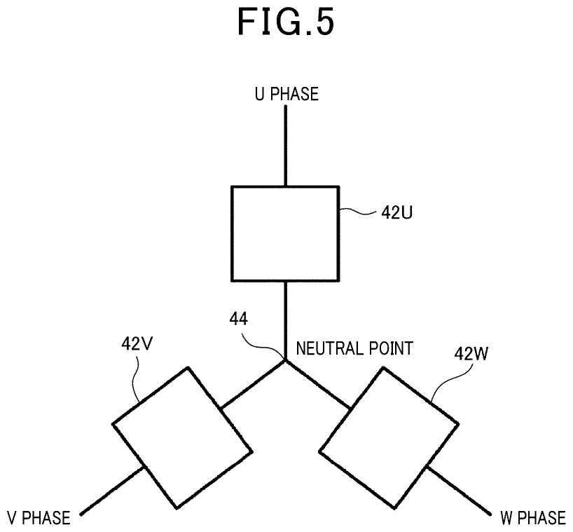

As shown in FIG. 5, those coil units 16 which together constitute a U phase (or U-phase coil group 42U), those coil units 16 which together constitute a V phase (or V-phase coil group 42V) and those coil units 16 which together constitute a W phase (or W-phase coil group 42W) are star-connected.

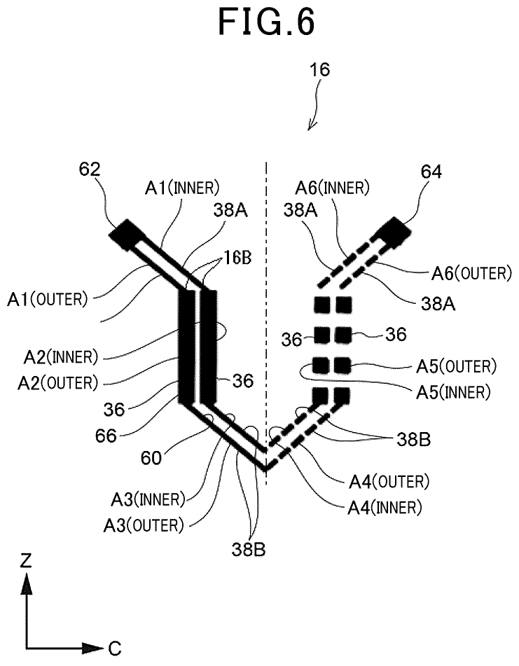

FIG. 6 shows a single coil unit 16 that constitutes a member of the U-phase coil group 42U. As shown in this figure, the coil unit 16 is formed to have, when viewed in the thickness direction of the band member 34, a substantially V-shape (or U-shape) that is open on a first side in the lateral direction of the band member 34 (i.e., on the first side in the axial direction) and closed on a second side in the lateral direction of the band member 34 (i.e., on the second side in the axial direction).

Specifically, the coil unit 16 has: a first straight portion A1 that is inclined toward the second side in the axial direction as it extends toward the first side in the circumferential direction; and a second straight portion A2 that extends, from an end of the first straight portion A1 on the first side in the circumferential direction, toward the second side in the axial direction. Moreover, the coil unit 16 also has: a third straight portion A3 that is inclined toward the second side in the axial direction as it extends, from an end of the second straight portion A2 on a side not connected to the first straight portion A1, toward the first side in the circumferential direction; and a fourth straight portion A4 that is inclined toward the first side in the axial direction as it extends, from an end of the third straight portion A3 on a side not connected to the second straight portion A2, toward the first side in the circumferential direction. Furthermore, the coil unit 16 also has: a fifth straight portion A5 that extends, from an end of the fourth straight portion A4 on a side not connected to the third straight portion A3, toward the first side in the axial direction; and a sixth straight portion A6 that is inclined toward the first side in the axial direction as it extends, from an end of the fifth straight portion A5 on a side not connected to the fourth straight portion A4, toward the first side in the circumferential direction. It should be noted that in the following explanation, the first straight portion A1 to the sixth straight portion A6 will be referred to as the electrical conductor portions 16B depending on the situation. The coil assembly 32 is configured so that the electrical conductor portions 16B are arranged regularly in the circumferential direction.

As shown in FIGS. 4, 6 and 7, the first straight portion A1, the second straight portion A2 and the third straight portion A3 are formed on a first surface 34A (i.e., radially inner surface) of the band member 34. On the other hand, the fourth straight portion A4, the fifth straight portion A5 and the sixth straight portion A6 are formed on a second surface 34B (i.e., radially outer surface) of the band member 34. Moreover, the third straight portion A3 and the fourth straight portion A4 are electrically connected with each other through a via or through-hole (not shown) that penetrates the band member 34. It should be noted that in the figures, those portions of the coil unit 16 which are formed on the first surface 34A of the band member 34 are shown by solid lines, whereas those portions of the coil unit 16 which are formed on the second surface 34B of the band member 34 are shown by dashed lines.

It should be noted that the second straight portion A2 and the fifth straight portion A5 described above may be referred to as vertical portions 36. Moreover, it also should be noted that: the first straight portion A1 and the sixth straight portion A6 may be referred to as coil end portions 38A on the first side in the axial direction; and the third straight portion A3 and the fourth straight portion A4 may be referred to as coil end portions 38B on the second side in the axial direction. In addition, the circumferential distance between the first straight portion A1 and the sixth straight portion A6 gradually increases toward the first side in the axial direction.

Moreover, each of the first straight portion A1, the second straight portion A2, the third straight portion A3, the fourth straight portion A4, the fifth straight portion A5 and the sixth straight portion A6 of the coil unit 16 is divided into two parts in the circumferential direction. More precisely, each of the first straight portion A1, the second straight portion A2, the third straight portion A3, the fourth straight portion A4, the fifth straight portion A5 and the sixth straight portion A6 of the coil unit 16 is divided into two parts in a direction perpendicular to the extending direction of the straight portion. In the following explanation, that part of the first straight portion A1 which is located closer to the circumferential center of the coil unit 16 will be referred to as the “first straight portion A1 (inner)”; and that part of the first straight portion A1 which is located further from the circumferential center of the coil unit 16 will be referred to as the “first straight portion A1 (outer)”. Similarly, each of the second straight portion A2, the third straight portion A3, the fourth straight portion A4, the fifth straight portion A5 and the sixth straight portion A6 will be explained with the denotation (inner) or (outer) added to the end of the reference sign designating the straight portion. It should be noted that in consideration of the ease of viewing the drawings, the denotation (inner) or (outer) is omitted from some of the reference sings designating the straight portions in the drawings.

As shown in FIG. 6, the first straight portion A1 (inner) and the first straight portion A1 (outer) are separated by a slit 60 formed therebetween and extend parallel to each other.

Similarly, the second straight portion A2 (inner) and the second straight portion A2 (outer) are separated by the slit 60 formed therebetween and extend parallel to each other. Moreover, the second straight portion A2 (inner) and the second straight portion A2 (outer) are connected respectively with the first straight portion A1 (inner) and the first straight portion A1 (outer).

The third straight portion A3 (inner) and the third straight portion A3 (outer) are separated by the slit 60 formed therebetween and extend parallel to each other. Moreover, the third straight portion A3 (inner) and the third straight portion A3 (outer) are connected respectively with the second straight portion A2 (inner) and the second straight portion A2 (outer).

The fourth straight portion A4 (inner) and the fourth straight portion A4 (outer) are separated by the slit 60 formed therebetween and extend parallel to each other. Moreover, the fourth straight portion A4 (inner) and the fourth straight portion A4 (outer) are connected respectively with the third straight portion A3 (inner) and the third straight portion A3 (outer).

The fifth straight portion A5 (inner) and the fifth straight portion A5 (outer) are separated by the slit 60 formed therebetween and extend parallel to each other. Moreover, the fifth straight portion A5 (inner) and the fifth straight portion A5 (outer) are connected respectively with the fourth straight portion A4 (inner) and the fourth straight portion A4 (outer).

The sixth straight portion A6 (inner) and the sixth straight portion A6 (outer) are separated by the slit 60 formed therebetween and extend parallel to each other. Moreover, the sixth straight portion A6 (inner) and the sixth straight portion A6 (outer) are connected respectively with the fifth straight portion A5 (inner) and the fifth straight portion A5 (outer).

An end of the first straight portion A1 (inner) on a side not connected to the second straight portion A2 (inner) and an end of the first straight portion A1 (outer) on a side not connected to the second straight portion A2 (outer) are connected with each other via a first connection portion 62. The first connection portion 62 is constituted of a part of the first straight portion A1. On the other hand, an end of the sixth straight portion A6 (inner) on a side not connected to the fifth straight portion A5 (inner) and an end of the sixth straight portion A6 (outer) on a side not connected to the fifth straight portion A5 (outer) are connected with each other via a second connection portion 64. The second connection portion 64 is constituted of a part of the sixth straight portion A6. Consequently, a closed circuit 66 is formed which has two paths connected with each other by the first connection portion 62 and the second connection portion 64; one of the two paths includes the first straight portion A1 (outer), the second straight portion A2 (outer), the third straight portion A3 (outer), the fourth straight portion A4 (outer), the fifth straight portion A5 (outer) and the sixth straight portion A6 (outer), whereas the other of the two paths includes the first straight portion A1 (inner), the second straight portion A2 (inner), the third straight portion A3 (inner), the fourth straight portion A4 (inner), the fifth straight portion A5 (inner) and the sixth straight portion A6 (inner).

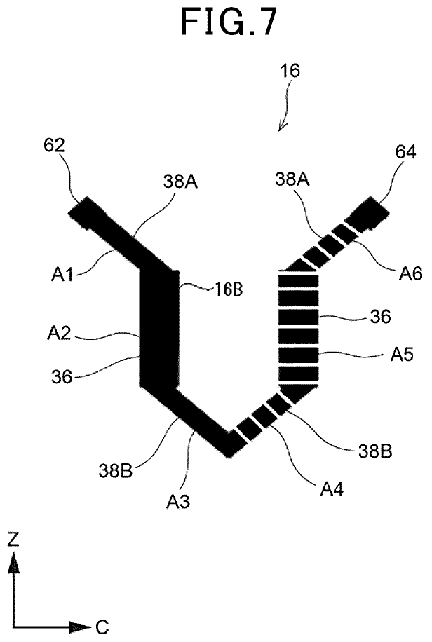

In the above-described example, the coil unit 16 is configured so that each portion of the coil unit 16 is divided into two parts in the circumferential direction by the slit 60. However, the present disclosure is not limited to this configuration. For example, as shown in FIG. 7, the coil unit 16 may alternatively be configured so that no portion of the coil unit 16 is divided into two parts in the circumferential direction. Otherwise, the coil unit 16 may alternatively be configured so that each portion of the coil unit 16 is divided into three or more parts in the circumferential direction by slits 60. In addition, the coil unit 16 may alternatively be configured so that only part of the coil unit 16 is divided in the circumferential direction by one or more slits 60.

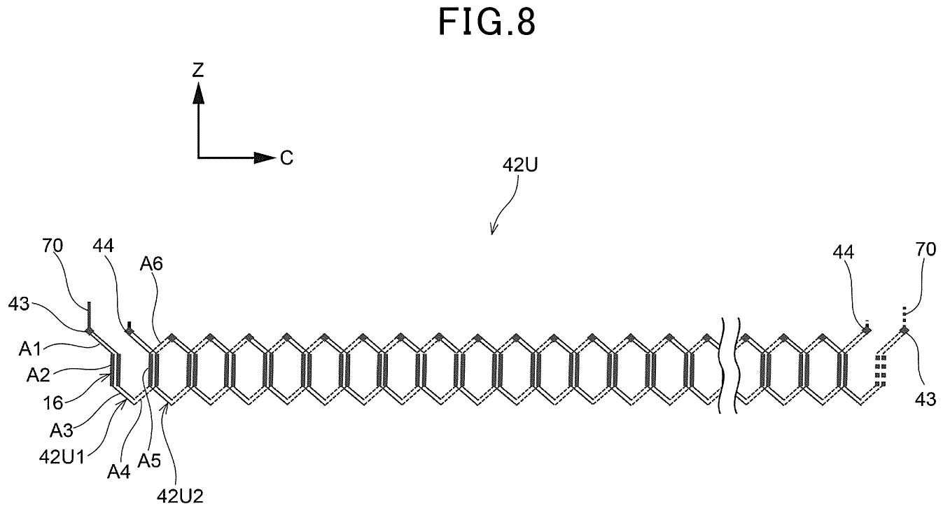

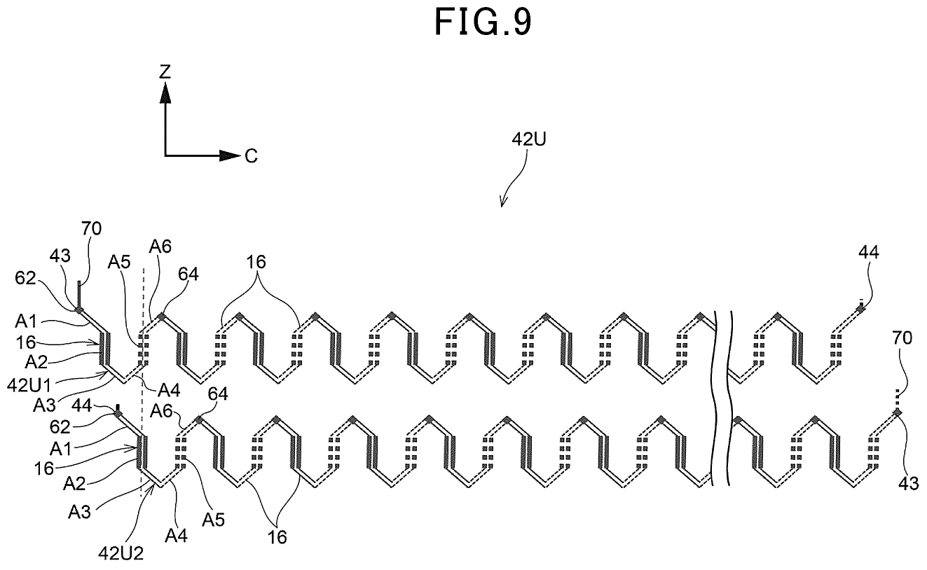

As shown in FIGS. 8 and 9, the other U-phase coil units 16 are configured similarly to the coil unit 16 shown in FIG. 6. That is, all the U-phase coil units 16 have substantially the same configuration.

FIG. 8 shows the U-phase coil units 16 formed on the band member 34. As shown in this figure, half of the U-phase coil units 16 are connected in series with each other; hereinafter, these U-phase coil units 16 connected in series with each other will be referred to as a first U-phase coil group 42U1. On the other hand, the remaining half of the U-phase coil units 16 are also connected in series with each other; hereinafter, these U-phase coil units 16 connected in series with each other will be referred to as a second U-phase coil group 42U2. That is, the U-phase coil group 42U consists of the first U-phase coil group 42U1 and the second U-phase coil group 42U2. Moreover, the first U-phase coil group 42U1 and the second U-phase coil group 42U2 are connected in parallel with each other.

FIG. 9 is a schematic diagram showing the coil units 16 constituting the first U-phase coil group 42U1 and the coil units 16 constituting the second U-phase coil group 42U2, with the first and second U-phase coil groups 42U1 and 42U2 offset from each other in the axial direction. As shown in this figure, the coil units 16 constituting the first U-phase coil group 42U1 are arranged at predetermined intervals in the circumferential direction. Moreover, for each circumferentially-adjacent pair of the coil units 16 constituting the first U-phase coil group 42U1, the first connection portion 62 of one of the pair of the coil units 16 and the second connection portion 64 of the other of the pair of the coil units 16 are connected with each other through a via, a through-hole or the like.

Similar to the coil units 16 constituting the first U-phase coil group 42U1, the coil units 16 constituting the second U-phase coil group 42U2 are also arranged at predetermined intervals in the circumferential direction. Moreover, for each circumferentially-adjacent pair of the coil units 16 constituting the second U-phase coil group 42U2, the first connection portion 62 of one of the pair of the coil units 16 and the second connection portion 64 of the other of the pair of the coil units 16 are connected with each other through a via, a through-hole or the like.

The coil units 16 constituting the second U-phase coil group 42U2 are offset from the coil units 16 constituting the first U-phase coil group 42U1 to the first side in the circumferential direction. The offset distance between the first U-phase coil group 42U1 and the second U-phase coil group 42U2 corresponds to the circumferential distance between the second straight portion A2 and the fifth straight portion A5 in each of the coil units 16. Consequently, the fifth straight portions A5 of the coil units 16 constituting the first U-phase coil group 42U1 respectively radially overlap the second straight portions A2 of the coil units 16 constituting the second U-phase coil group 42U2 via the band member 34. Moreover, the second straight portions A2 of the coil units 16 constituting the first U-phase coil group 42U1 respectively radially overlap the fifth straight portions A5 of the coil units 16 constituting the second U-phase coil group 42U2 via the band member 34.

The first connection portion 62 of that one of the coil units 16 constituting the first U-phase coil group 42U1 which is located furthest to the second side in the circumferential direction constitutes an input point 43 connected to an electric power source. On the other hand, the second connection portion 64 of that one of the coil units 16 constituting the first U-phase coil group 42U1 which is located furthest to the first side in the circumferential direction constitutes a neutral point 44.

The first connection portion 62 of that one of the coil units 16 constituting the second U-phase coil group 42U2 which is located furthest to the second side in the circumferential direction constitutes a neutral point 44. On the other hand, the second connection portion 64 of that one of the coil units 16 constituting the second U-phase coil group 42U2 which is located furthest to the first side in the circumferential direction constitutes an input point 43 connected to the electric power source.

Although detailed explanation with reference signs shown in the drawings is omitted, the V-phase coil group 42V has the same configuration as the U-phase coil group 42U except for the following points, as shown in FIG. 4. The V-phase coil group 42V consists of a first V-phase coil group and a second V-phase coil group. The first V-phase coil group and the second V-phase coil group are connected in parallel with each other. The first connection portion 62 of that one of the coil units 16 constituting the first V-phase coil group which is located furthest to the second side in the circumferential direction constitutes a neutral point 44. On the other hand, the second connection portion 64 of that one of the coil units 16 constituting the first V-phase coil group which is located furthest to the first side in the circumferential direction constitutes an input point 43 connected to the electric power source. Moreover, the first connection portion 62 of that one of the coil units 16 constituting the second V-phase coil group which is located furthest to the second side in the circumferential direction constitutes an input point 43 connected to the electric power source. On the other hand, the second connection portion 64 of that one of the coil units 16 constituting the second V-phase coil group which is located furthest to the first side in the circumferential direction constitutes a neutral point 44.

The W-phase coil group 42W also has the same configuration as the U-phase coil group 42U except for the following points. The W-phase coil group 42W consists of a first W-phase coil group and a second W-phase coil group. The first W-phase coil group and the second W-phase coil group are connected in parallel with each other. The first connection portion 62 of that one of the coil units 16 constituting the first W-phase coil group which is located furthest to the second side in the circumferential direction constitutes an input point 43 connected to the electric power source. On the other hand, the second connection portion 64 of that one of the coil units 16 constituting the first W-phase coil group which is located furthest to the first side in the circumferential direction constitutes an input point 43 connected to a neutral point 44. Moreover, the first connection portion 62 of that one of the coil units 16 constituting the second W-phase coil group which is located furthest to the second side in the circumferential direction constitutes a neutral point 44. On the other hand, the second connection portion 64 of that one of the coil units 16 constituting the second W-phase coil group which is located furthest to the first side in the circumferential direction constitutes an input point 43 connected to the electric power source.

As shown in FIG. 4, the coil units 16 constituting the V-phase coil group 42V are offset from the coil units 16 constituting the U-phase coil group 42U to the first side in the circumferential direction. Moreover, the coil units 16 constituting the W-phase coil group 42W are offset from the coil units 16 constituting the V-phase coil group 42V to the first side in the circumferential direction. Consequently, the U-phase coil units 16, the V-phase coil units 16 and the W-phase coil units 16 are arranged in this order along the circumferential direction. It should be noted that in the following explanation, depending on the situation, the U-phase coil units 16 will be simply referred to as the coil units 16U; the V-phase coil units 16 will be simply referred to as the coil units 16V; and the W-phase coil units 16 will be simply referred to as the coil units 16W.

From those input points 43 of the coil units 16U, 16V and 16W which are located on an end part of the band member 34 on the second side in the circumferential direction, input lines 70 respectively extend toward the first side in the axial direction. Similarly, from those input points 43 of the coil units 16U, 16V and 16W which are located on an end part of the band member 34 on the first side in the circumferential direction, input lines 70 respectively extend toward the first side in the axial direction.

Those neutral points 44 of the coil units 16U, 16V and 16W which are arranged on the end part of the band member 34 on the second side in the circumferential direction are connected with each other via a neutral-point connection pattern 72 formed on the band member 34. Similarly, those neutral points 44 of the coil units 16U, 16V and 16W which are arranged on the end part of the band member 34 on the first side in the circumferential direction are also connected with each other via a neutral-point connection pattern 72 formed on the band member 34.

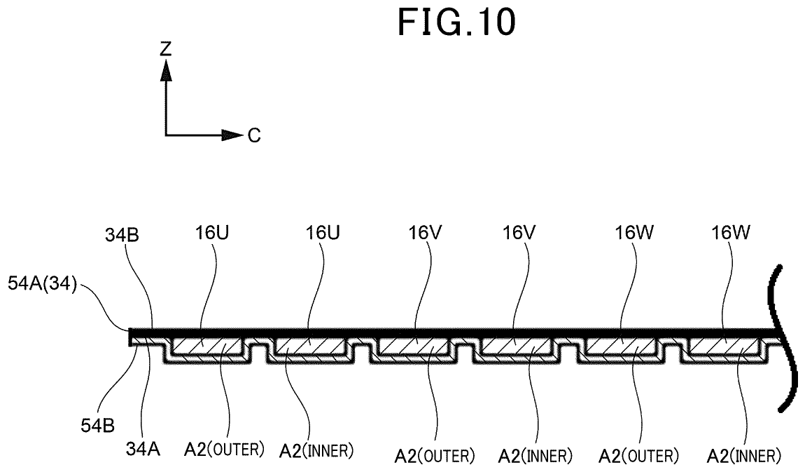

FIG. 10 shows a part of a cross section of the band member 34 and the second straight portions A2 and fifth straight portions A5 of the coil units 16 taken along the line A-A in FIG. 4. It should be noted that the part of the cross section shown in FIG. 10 includes the cross section of the end part of the band member 34 on the second side in the circumferential direction. As shown in FIG. 10, in this part of the cross section, the second straight portion A2 (outer) and second straight portion A2 (inner) of one of the coil units 16U, the second straight portion A2 (outer) and second straight portion A2 (inner) of one of the coil units 16V and the second straight portion A2 (outer) and second straight portion A2 (inner) of one of the coil units 16W are formed in this order on the first surface 34A of the band member 34.

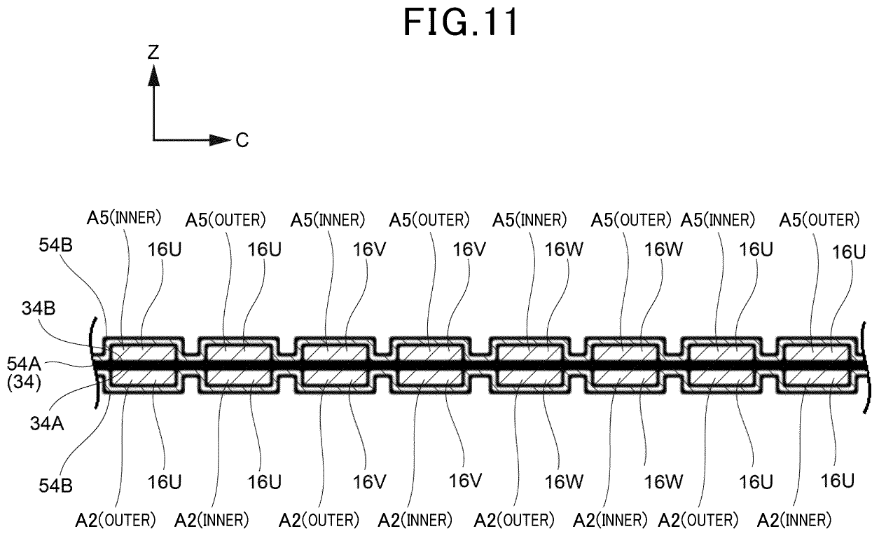

FIG. 11 shows another part of the cross section of the band member 34 and the second straight portions A2 and fifth straight portions A5 of the coil units 16 taken along the line A-A in FIG. 4. It should be noted that the part of the cross section shown in FIG. 11 corresponds to a range indicated by the arrow E in FIG. 4. In the part of the cross section shown in FIG. 11, the second straight portion A2 (outer) and second straight portion A2 (inner) of one of the coil units 16U, the second straight portion A2 (outer) and second straight portion A2 (inner) of one of the coil units 16V, the second straight portion A2 (outer) and second straight portion A2 (inner) of one of the coil units 16W and the second straight portion A2 (outer) and second straight portion A2 (inner) of another one of the coil units 16U are formed in this order on the first surface 34A of the band member 34. Moreover, in the part of the cross section shown in FIG. 11, the fifth straight portion A5 (inner) and fifth straight portion A5 (outer) of one of the coil units 16U, the fifth straight portion A5 (inner) and fifth straight portion A5 (outer) of one of the coil units 16V, the fifth straight portion A5 (inner) and fifth straight portion A5 (outer) of one of the coil units 16W and the fifth straight portion A5 (inner) and fifth straight portion A5 (outer) of another one of the coil units 16U are formed in this order on the second surface 34B of the band member 34.

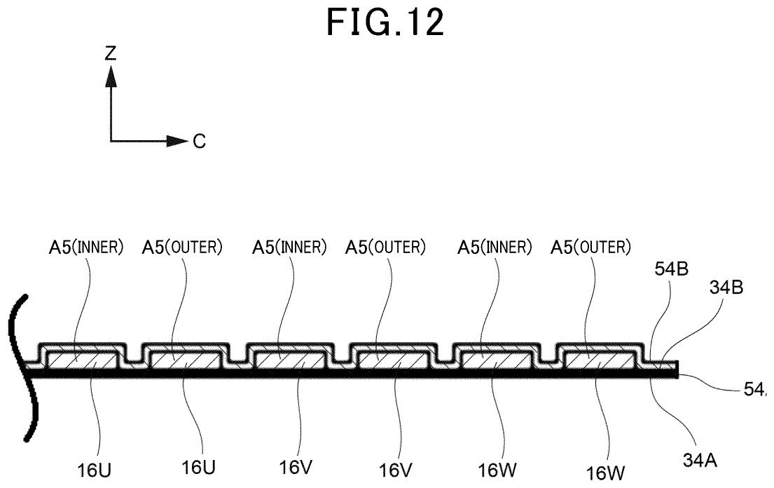

FIG. 12 shows yet another part of the cross section of the band member 34 and the second straight portions A2 and fifth straight portions A5 of the coil units 16 taken along the line A-A in FIG. 4. It should be noted that the part of the cross section shown in FIG. 12 includes the cross section of the end part of the band member 34 on the first side in the circumferential direction. As shown in FIG. 12, in this part of the cross section, the fifth straight portion A5 (inner) and fifth straight portion A5 (outer) of one of the coil units 16U, the fifth straight portion A5 (inner) and fifth straight portion A5 (outer) of one of the coil units 16V and the fifth straight portion A5 (inner) and fifth straight portion A5 (outer) of one of the coil units 16W are formed in this order on the second surface 34B of the band member 34.

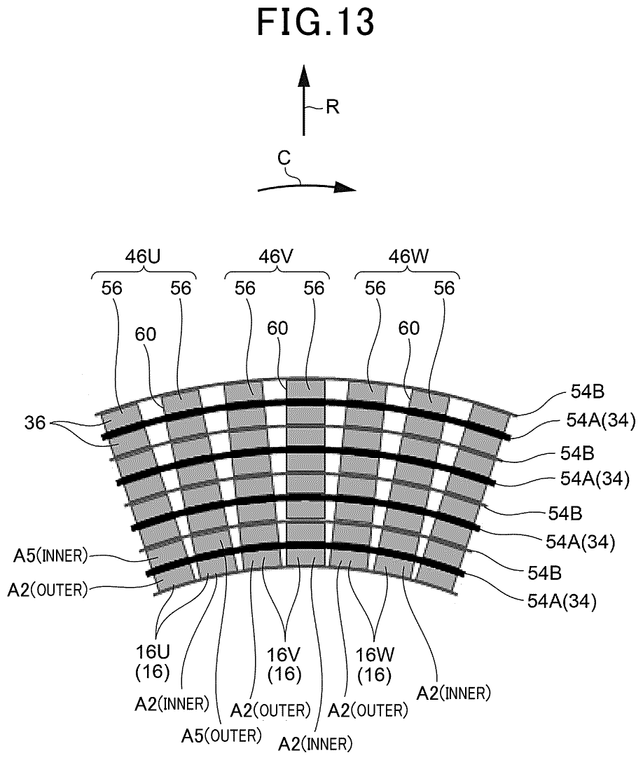

As described above, the band member 34 is rolled along the circumferential direction a plurality of times so that the coil units 16 are located at predetermined positions in the circumferential direction and the radial direction. FIG. 13 shows a part of a cross section of the coil assembly 32 taken along the radial direction, where the band member 34 is in the rolled state. It should be noted that this cross section of the coil assembly 32 is a cross section corresponding to the vertical portions 36 (see FIG. 6) of the coil units 16.

In the cross section shown in FIG. 13, the vertical portions 36 of the coil units 16 are laminated in the radial direction and arranged at equal intervals in the circumferential direction. Moreover, in the state where the vertical portions 36 of the coil units 16 are laminated in the radial direction, a first insulating layer 54A or a second insulating layer 54B is interposed between each radially-adjacent pair of the vertical portions 36. The first insulating layer 54A is constituted of the band member 34 which may be formed of, for example, a polyimide film or insulating paper. On the other hand, as shown in FIGS. 10 to 13, the second insulating layer 54B is constituted of an insulating film that is formed to cover the coil units 16 formed on the band member 34. The insulating film may be formed of, for example, an electrically-insulative paint. Moreover, as the electrically-insulative paint, a polyimide coating film, varnish or the like may be employed.

Hereinafter, all the laminates in each of which the vertical portions 36 of the coil units 16 are laminated in the radial direction as shown in FIG. 13 will be referred to as the vertical-portion laminates 56. That is, the vertical-portion laminates 56 include: those laminates in each of which the second straight portions A2 (outer) of the coil units 16U and the fifth straight portions A5 (inner) of the coil units 16U are laminated in the radial direction; those laminates in each of which the second straight portions A2 (inner) of the coil units 16U and the fifth straight portions A5 (outer) of the coil units 16U are laminated in the radial direction; those laminates in each of which the second straight portions A2 (outer) of the coil units 16V and the fifth straight portions A5 (inner) of the coil units 16V are laminated in the radial direction; those laminates in each of which the second straight portions A2 (inner) of the coil units 16V and the fifth straight portions A5 (outer) of the coil units 16V are laminated in the radial direction; those laminates in each of which the second straight portions A2 (outer) of the coil units 16W and the fifth straight portions A5 (inner) of the coil units 16W are laminated in the radial direction; and those laminates in each of which the second straight portions A2 (inner) of the coil units 16W and the fifth straight portions A5 (outer) of the coil units 16W are laminated in the radial direction.

As shown in FIG. 13, one of the vertical-portion laminates 56 in which the second straight portion A2 (outer) of one of the coil units 16U is located at the radially inner end and one of the vertical-portion laminates 56 in which the second straight portion A2 (inner) of one of the coil units 16U is located at the radially inner end are arranged in this order in the circumferential direction to together constitute a U-phase electrical conductor group 46U. Moreover, one of the vertical-portion laminates 56 in which the second straight portion A2 (outer) of one of the coil units 16V is located at the radially inner end and one of the vertical-portion laminates 56 in which the second straight portion A2 (inner) of one of the coil units 16V is located at the radially inner end are arranged in this order in the circumferential direction to together constitute a V-phase electrical conductor group 46V. Furthermore, one of the vertical-portion laminates 56 in which the second straight portion A2 (outer) of one of the coil units 16W is located at the radially inner end and one of the vertical-portion laminates 56 in which the second straight portion A2 (inner) of one of the coil units 16W is located at the radially inner end are arranged in this order in the circumferential direction to together constitute a W-phase electrical conductor group 46W.

### Operation and Effects

Next, operation and effects of the motor 10 configured as described above will be described.

As shown in FIGS. 1, 2, 4 and 5, in the motor 10, a rotating magnetic field is generated in the stator 14 by switching of the energization of the U-phase coil group 42U, the V-phase coil group 42V and the W-phase coil group 42W that constitute part of the stator 14. Consequently, the rotor 12 is caused by the rotating magnetic field to rotate.

In the motor 10, the coil assembly 32 includes the band member 34 formed of an electrically-insulative material in a band shape, and the coil units 16 formed on the band member 34. Moreover, the band member 34 is rolled along the circumferential direction a plurality of times so that the coil units 16 are located at predetermined positions in the circumferential direction and the radial direction. With this configuration, it becomes possible to suppress increase in the size of the coil assembly 32 in the radial direction. As a result, it becomes possible to suppress increase in the size of the motor 10.

As shown in FIGS. 4, 8 and 9, each of the coil units 16 is formed to have a substantially V-shape when viewed in the thickness direction of the band member 34. Moreover, for each circumferentially-adjacent pair of the coil units 16, the first connection portion 62 of one of the pair of the coil units 16 and the second connection portion 64 of the other of the pair of the coil units 16 are connected with each other on the first side of the band member 34 in the axial direction. With the above configuration, it becomes unnecessary to provide any additional wiring path for connecting the coil units 16 on the band member 34; thus, it becomes possible to suppress increase in the size of the coil assembly 32 in the axial direction. Consequently, it becomes possible to suppress increase in the size of the motor 10. Moreover, without the necessity of providing any additional wiring path for connecting the coil units 16 on the band member 34, it becomes possible to suppress increase in the lengths of wiring paths between the coil units 16. As a result, it becomes possible to reduce the electrical resistances between the coil units 16, thereby achieving improvement in the torque of the motor 10.

As shown in FIGS. 6 and 13, each of the portions of the coil units 16 is divided into two parts in the circumferential direction by a slit 60. Consequently, it becomes possible to reduce the area of each of the vertical-portion laminates 56 facing the magnets 18 of the rotor 12. As a result, it becomes possible to suppress generation of eddy current in the vertical-portion laminates 56 due to the radial magnetic flux, thereby further improving the torque of the motor 10.

As shown in FIGS. 6 and 9, the circumferential distance between the first straight portion A1 and the sixth straight portion A6 in each of the coil units 16 gradually increases toward the first side in the axial direction. Consequently, it becomes possible to facilitate the connection between circumferentially adjacent coil units 16 on both circumferential sides of the second straight portion A2 and fifth straight portion A5 of each of the coil units 16.

The vertical-portion laminates 56 are formed by laminating the coil units 16 of a same one of the U-phase, V-phase and W-phase coil groups 42U, 42V and 42W in the radial direction. Consequently, it becomes possible to achieve, by adjusting the number of layers of the coil units 16, the same effects as achievable by adjusting the number of turns. It should be noted that the number of turns here denotes the number of turns of a coil formed by winding an electroconductive wire.

### Configurations for Improving Space Factor of Coil Assembly 32

Next, the configurations for improving the space factor of the coil assembly 32 according to embodiments will be described. It should be noted that in the drawings used in the following description, hatching lines indicating cross sections are omitted.

### First Embodiment

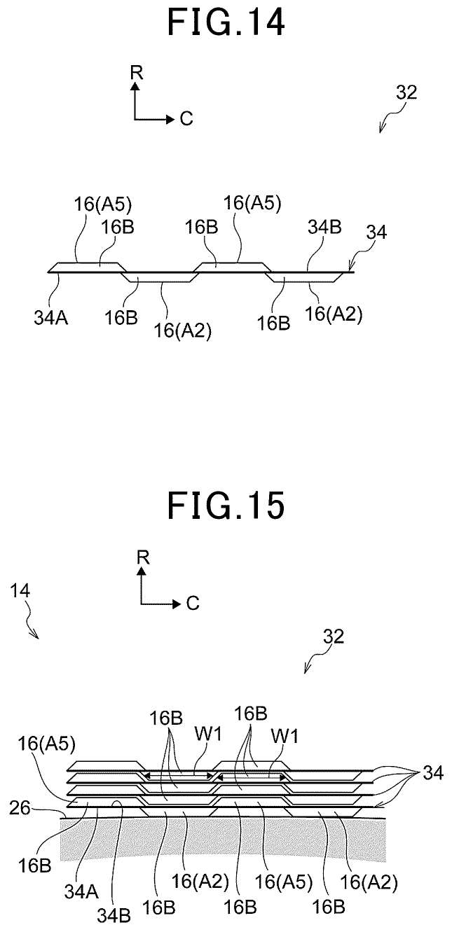

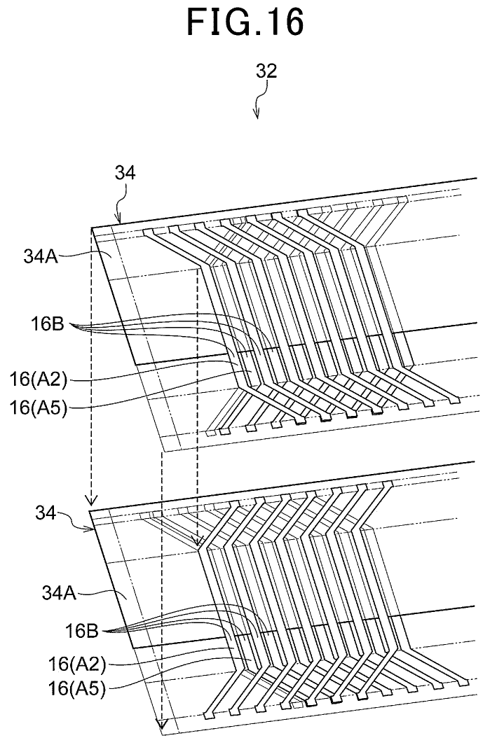

A motor according to the first embodiment will be described with reference to FIGS. 14 to 18. It should be noted that: members and parts of the motor according to the first embodiment corresponding to those of the motor 10 described above are designated by the same reference signs as the corresponding members and parts of the motor 10; and description of these parts and members will be omitted hereinafter.

FIGS. 14 and 15 show cross sections, taken along the radial direction, of parts of the coil assembly 32 of the motor according to the first embodiment. Specifically, FIG. 14 shows a cross section of a part of a band member 34 of a specific layer and the coil units 16 (more specifically, electrical conductor portions 16B) formed on the part of the band member 34. FIG. 15 shows a cross section of parts of band members 34 of a plurality of layers and the coil units 16 (more specifically, electrical conductor portions 16B) formed on the parts of the band members 34. As shown in FIGS. 14, 15 and 16, in the present embodiment, in the state of the band member 34 of a first layer and the band member 34 of a second layer having been laminated in the radial direction, the electrical conductor portions 16B formed on the band member 34 of the first layer and the electrical conductor portions 16B formed on the band member 34 of the second layer are arranged alternately along the circumferential direction. Moreover, in the state of the band member 34 of the first layer and the band member 34 of the second layer having been laminated in the radial direction, the electrical conductor portions 16B formed on the band member 34 of the first layer and the electrical conductor portions 16B formed on the band member 34 of the second layer overlap one another in the circumferential direction. Consequently, it becomes possible to improve the space factor of the coil assembly 32 of the motor according to the present embodiment in comparison with that of the coil assembly 32 of the motor 10 described above. It should be noted that unlike the coil assembly 32 of the motor 10 described above, the coil assembly 32 of the motor according to the present embodiment has a plurality of band members 34, each of which is rolled in an annular shape, laminated in layers in the radial direction. In addition, the number of layers of the coil assembly 32 may be suitably set in consideration of the output and the like required of the motor.

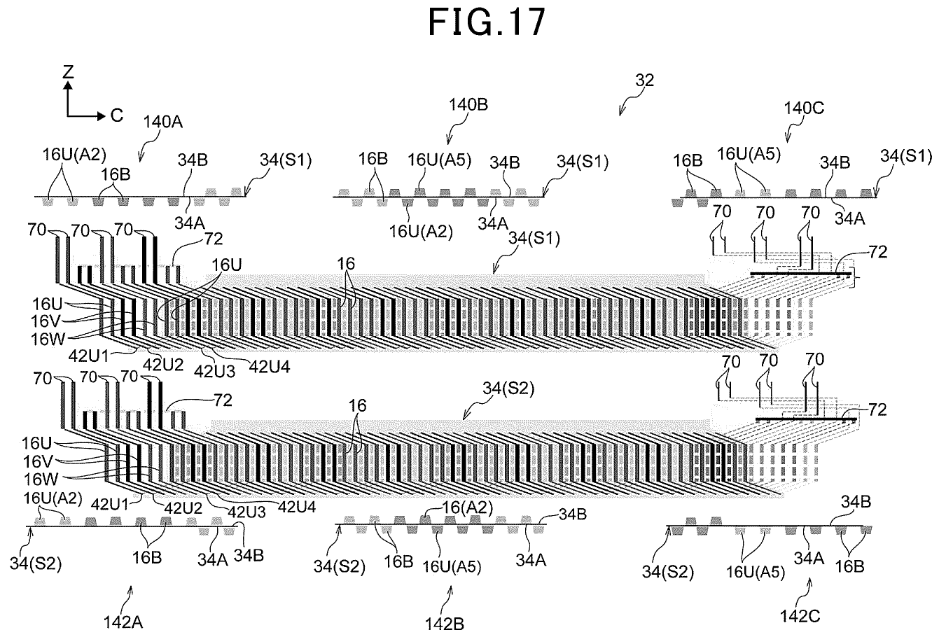

FIG. 17 shows a planar development of both the band member 34 of the first layer and the band member 34 of the second layer which is located radially adjacent to the band member 34 of the first layer in the coil assembly 32 of the motor according to the present embodiment. It should be noted that: the band member of the first layer is designated by the reference numeral 34 suffixed with (S1); and the band member of the second layer is designated by the reference numeral 34 suffixed with (S2).

As shown in FIG. 17 (see also FIG. 7), on the band member 34 (S1) of the first layer, there are formed a plurality of U-phase coil units 16U. It should be noted that in FIG. 17, those portions of the coil units 16 which are formed on a first surface 34A of the band member 34 (S1) of the first layer are shown by solid lines, whereas those portions of the coil units 16 which are formed on a second surface 34B of the band member 34 (S1) of the first layer are shown by dashed lines. In FIG. 17, there are also shown: a cross section 140A of an end part of the band member 34 (S1) of the first layer on the second side in the circumferential direction; a cross section 140B of a circumferential intermediate part of the band member 34 (S1) of the first layer; and a cross section 140C of an end part of the band member 34 (S1) of the first layer on the first side in the circumferential direction. Each of the cross sections 140A, 140B and 140C is taken along the radial direction at a location corresponding to the second straight portions A2 and the fifth straight portions A5 of the coil units 16.

Specifically, on the band member 34 (S1) of the first layer, there are formed twenty U-phase coil units 16U. Moreover, of the twenty U-phase coil units 16U, five coil units 16U are connected in series with each other to together constitute a first U-phase coil group 42U1; another five coil units 16U are connected in series with each other to together constitute a second U-phase coil group 42U2; yet another five coil units 16U are connected in series with each other to together constitute a third U-phase coil group 42U3; and still another five coil units 16U are connected in series with each other to together constitute a fourth U-phase coil group 42U4.

The second U-phase coil group 42U2 is offset from the first U-phase coil group 42U1 to the first side in the circumferential direction. The offset distance D1 between the first U-phase coil group 42U1 and the second U-phase coil group 42U2 is set to a value that allows a coil unit 16U to be arranged between a circumferentially-adjacent pair of one of the coil units 16U of the first U-phase coil group 42U1 and one of the coil units 16U of the second U-phase coil group 42U2. For example, the offset distance D1 may be set to a value slightly greater than the width of each of the second straight portions A2 of the coil units 16 in the circumferential direction. Moreover, the portions (i.e., the first straight portion A1 to the sixth straight portion A6) of each of the coil units 16U constituting the first U-phase coil group 42U1 and the portions (i.e., the first straight portion A1 to the sixth straight portion A6) of each of the coil units 16U constituting the second U-phase coil group 42U2 are arranged adjacent to one another in the circumferential direction. Furthermore, the first U-phase coil group 42U1 and the second U-phase coil group 42U2 are connected in parallel with each other.

The coil units 16U constituting the third U-phase coil group 42U3 and the coil units 16U constituting the fourth U-phase coil group 42U4 are offset from the coil units 16U constituting the first U-phase coil group 42U1 and the coil units 16U constituting the second U-phase coil group 42U2 to the first side in the circumferential direction, with two V-phase coil units 16V and two W-phase coil units 16W interposed therebetween.

The fourth U-phase coil group 42U4 is offset by the offset distance D1 from the third U-phase coil group 42U3 to the first side in the circumferential direction. Moreover, the portions (i.e., the first straight portion A1 to the sixth straight portion A6) of each of the coil units 16U constituting the third U-phase coil group 42U3 and the portions (i.e., the first straight portion A1 to the sixth straight portion A6) of each of the coil units 16U constituting the fourth U-phase coil group 42U4 are arranged adjacent to one another in the circumferential direction. Furthermore, the third U-phase coil group 42U3 and the fourth U-phase coil group 42U4 are connected in parallel with each other.

Moreover, the first U-phase coil group 42U1 and the second U-phase coil group 42U2 are connected in parallel with the third U-phase coil group 42U3 and the fourth U-phase coil group 42U4.

On the circumferential intermediate part of the band member 34 (S1) of the first layer excluding both the circumferential end parts thereof, the second straight portions A2 of the U-phase coil units 16U and the fifth straight portions A5 of different ones of the U-phase coil units 16U are circumferentially offset from one another and arranged alternately from the second side to the first side in the circumferential direction. That is, the second straight portion A2 of one of the U-phase coil units 16U and the fifth straight portion A5 of another one of the U-phase coil units 16U are arranged at different positions in the circumferential direction. In addition, after the circumferential end parts of the band member 34 (S1) of the first layer are overlapped with each other, in these circumferential end parts as well, the second straight portions A2 of the U-phase coil units 16U and the fifth straight portions A5 of different ones of the U-phase coil units 16U are circumferentially offset from one another and arranged alternately from the second side to the first side in the circumferential direction.

On the band member 34 (S1) of the first layer, there are also formed twenty V-phase coil units 16V that are offset from the twenty U-phase coil units 16U to the first side in the circumferential direction. The twenty V-phase coil units 16V are arranged and connected in the same manner as the twenty U-phase coil units 16U. Moreover, on the band member 34 (S1) of the first layer, there are also formed twenty W-phase coil units 16W that are offset from the twenty V-phase coil units 16V to the first side in the circumferential direction. The twenty W-phase coil units 16W are also arranged and connected in the same manner as the twenty U-phase coil units 16U.

On the band member 34 (S2) of the second layer, there are also formed a plurality of U-phase coil units 16U, a plurality of V-phase coil units 16V and a plurality of W-phase coil units 16W. It should be noted that in FIG. 17, those portions of the coil units 16 which are formed on a first surface 34A of the band member 34 (S2) of the second layer are shown by dashed lines, whereas those portions of the coil units 16 which are formed on a second surface 34B of the band member 34 (S2) of the second layer are shown by solid lines. That is, those portions of the coil units 16 formed on the band member 34 (S2) of the second layer which correspond to those portions of the coil units 16 which are formed on the first surface 34A of the band member 34 (S1) of the first layer are formed on the second surface 34B of the band member 34 (S2) of the second layer. On the other hand, those portions of the coil units 16 formed on the band member 34 (S2) of the second layer which correspond to those portions of the coil units 16 which are formed on the second surface 34B of the band member 34 (S1) of the first layer are formed on the first surface 34A of the band member 34 (S2) of the second layer. Moreover, in FIG. 17, there are also shown: a cross section 142A of an end part of the band member 34 (S2) of the second layer on the second side in the circumferential direction; a cross section 142B of a circumferential intermediate part of the band member 34 (S2) of the second layer; and a cross section 142C of an end part of the band member 34 (S2) of the second layer on the first side in the circumferential direction. Each of the cross sections 142A, 142B and 142C is taken along the radial direction at a location corresponding to the second straight portions A2 and the fifth straight portions A5 of the coil units 16.

Except for the above-described points, the configuration of the band member 34 (S2) of the second layer and the configuration of the coil units 16 formed on the band member 34 (S2) of the second layer are the same as the configuration of the band member 34 (S1) of the first layer and the configuration of the coil units 16 formed on the band member 34 (S1) of the first layer. Moreover, the pattern (or circuit type) of the coil units 16 formed on the band member 34 (S2) of the second layer matches the pattern (circuit type) of the coil units 16 formed on the band member 34 (S1) of the first layer.

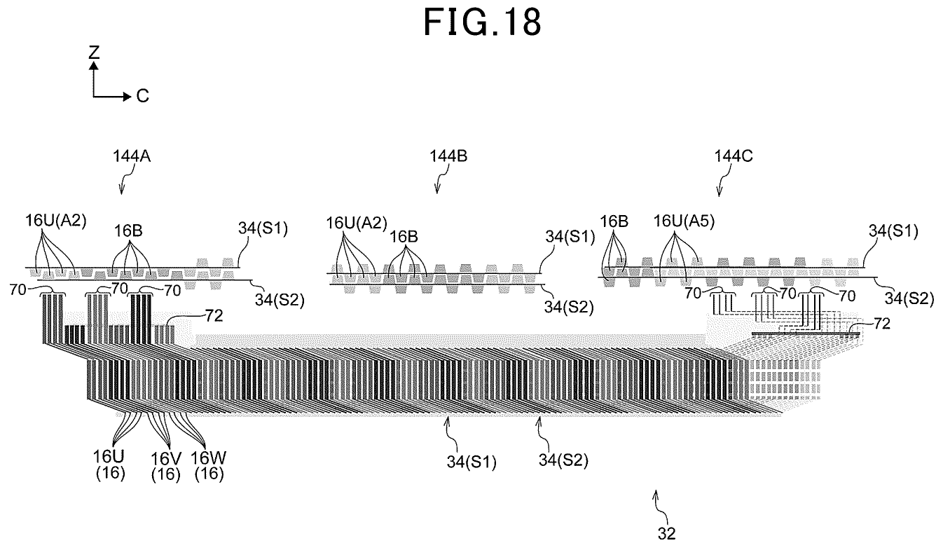

FIG. 18 shows the overlapped state (or laminated state) of the band member 34 (S1) of the first layer and the band member 34 (S2) of the second layer both of which are shown in FIG. 17. In FIG. 18, there are also shown: a cross section 144A of both the end part of the band member 34 (S1) of the first layer on the second side in the circumferential direction and the end part of the band member 34 (S2) of the second layer on the second side in the circumferential direction; a cross section 144B of both the circumferential intermediate part of the band member 34 (S1) of the first layer and the circumferential intermediate part of the band member 34 (S2) of the second layer; and a cross section 144C of both the end part of the band member 34 (S1) of the first layer on the first side in the circumferential direction and the end part of the band member 34 (S2) of the second layer on the first side in the circumferential direction. Each of the cross sections 144A, 144B and 144C is taken along the radial direction at a location corresponding to the second straight portions A2 and the fifth straight portions A5 of the coil units 16. As shown in FIG. 18, in the overlapped state of the band member 34 (S1) of the first layer and the band member 34 (S2) of the second layer, the portions of the coil units 16 (i.e., the electrical conductor portions 16B) formed on the band member 34 (S1) of the first layer and the portions of the coil units 16 (i.e., the electrical conductor portions 16B) formed on the band member 34 (S2) of the second layer are arranged alternately along the circumferential direction. Moreover, in the overlapped state of the band member 34 (S1) of the first layer and the band member 34 (S2) of the second layer, the electrical conductor portions 16B formed on the band member 34 (S1) of the first layer and the electrical conductor portions 16B formed on the band member 34 (S2) of the second layer overlap one another in the circumferential direction. Consequently, it becomes possible to improve the space factor of the coil assembly 32 of the motor according to the present embodiment.

Moreover, in the coil assembly 32 of the motor according to the present embodiment, it becomes possible to increase the circumferential intervals between the electrical conductor portions 16B on each of the band members 34. Consequently, it becomes possible to reduce limitations on the thicknesses of the electrical conductor portions 16B in the case of the electrical conductor portions 16B being formed on the band members 34 by, for example, performing an etching process. As a result, it becomes possible to increase the thicknesses of the electrical conductor portions 16B, thereby further increasing the space factor of the coil assembly 32.

In the coil assembly 32 of the motor according to the present embodiment, the pattern (or circuit type) of the coil units 16 formed on the band member 34 of one layer matches the pattern (circuit type) of the coil units 16 formed on the band member 34 (S1) of another layer. Consequently, it becomes possible to perform the pattern designs of the coil units 16 on the band members 34 of different layers in a similar way, thereby reducing the design man-hours.

As shown in FIGS. 14 and 15, in the coil assembly 32 of the motor according to the present embodiment, the circumferential width W1 of each of the electrical conductor portions 16B formed on the band member 34 (S1) of the first layer gradually decreases toward the band member 34 (S2) of the second layer. Moreover, the circumferential width W1 of each of the electrical conductor portions 16B formed on the band member 34 (S2) of the second layer gradually decreases toward the band member 34 (S1) of the first layer. Consequently, it becomes possible to facilitate, when overlapping the band member 34 (S1) of the first layer and the band member 34 (S2) of the second layer with each other, the arrangement of the electrical conductor portions 16B formed on the band member 34 (S2) of the second layer between the electrical conductor portions 16B formed on the band member 34 (S1) of the first layer.

### Second Embodiment

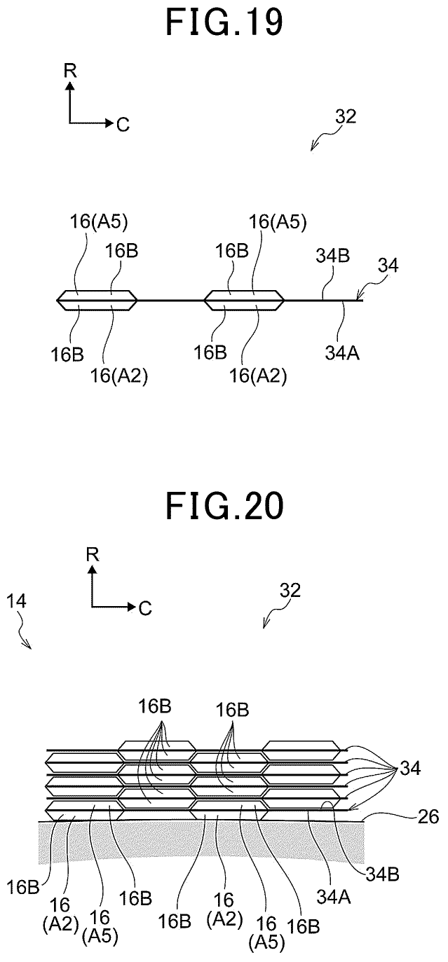

A motor according to the second embodiment will be described with reference to FIGS. 19 to 23. It should be noted that: members and parts of the motor according to the second embodiment corresponding to those of the motor 10 and the like described above are designated by the same reference signs as the corresponding members and parts of the motor 10 and the like; and description of these parts and members will be omitted hereinafter.

FIGS. 19 to 23 are diagrams for explaining the configuration of the coil assembly 32 of the motor according to the second embodiment, and correspond respectively to FIGS. 14 to 18 used for the explanation of the motor according to the first embodiment. As shown in these figures, the configuration of the coil assembly 32 of the motor according to the second embodiment is the same as that of the coil assembly 32 of the motor according to the first embodiment, except for the points to be described later.

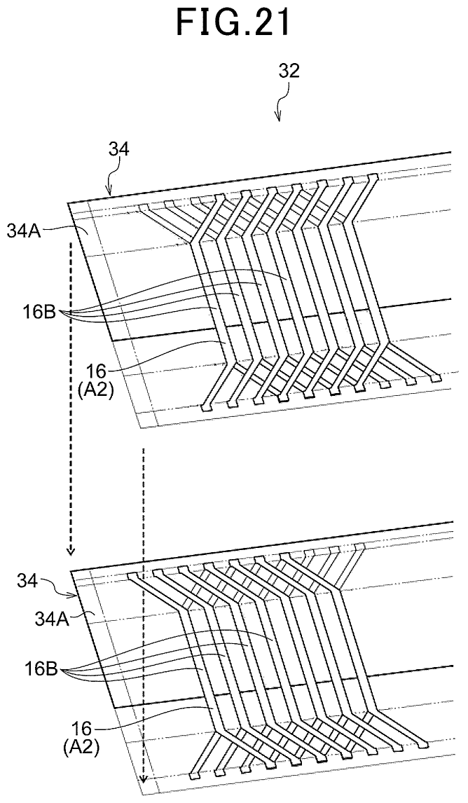

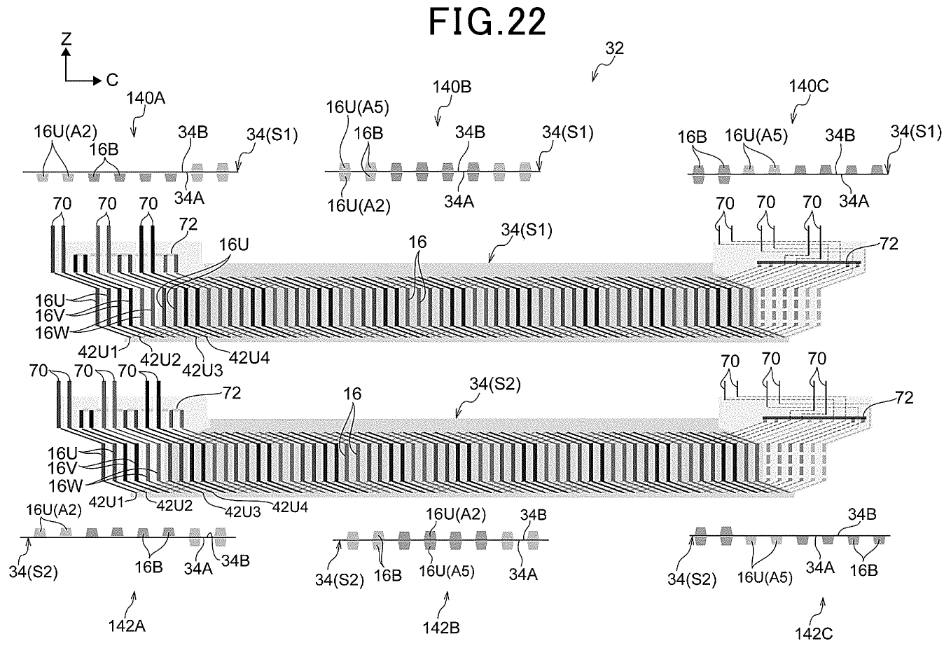

As shown in FIGS. 20 and 22, in the coil assembly 32 of the motor according to the second embodiment, on the circumferential intermediate part of the band member 34 (S1) of the first layer excluding both the circumferential end parts thereof, the second straight portion A2 of each U-phase coil unit 16U is arranged at the same circumferential position as the fifth straight portion A5 of another U-phase coil unit 16U. In addition, after the circumferential end parts of the band member 34 (S1) of the first layer are overlapped with each other, in these circumferential end parts as well, the second straight portion A2 of each U-phase coil unit 16U is arranged at the same circumferential position as the fifth straight portion A5 of another U-phase coil unit 16U.

The V-phase coil units 16V and the W-phase coil units 16W formed on the band member 34 (S1) of the first layer have the same configuration as the U-phase coil units 16U. Moreover, the coil units 16 formed on the band member 34 (S2) of the second layer have the same configuration as the coil units 16 formed on the band member 34 (S1) of the first layer.

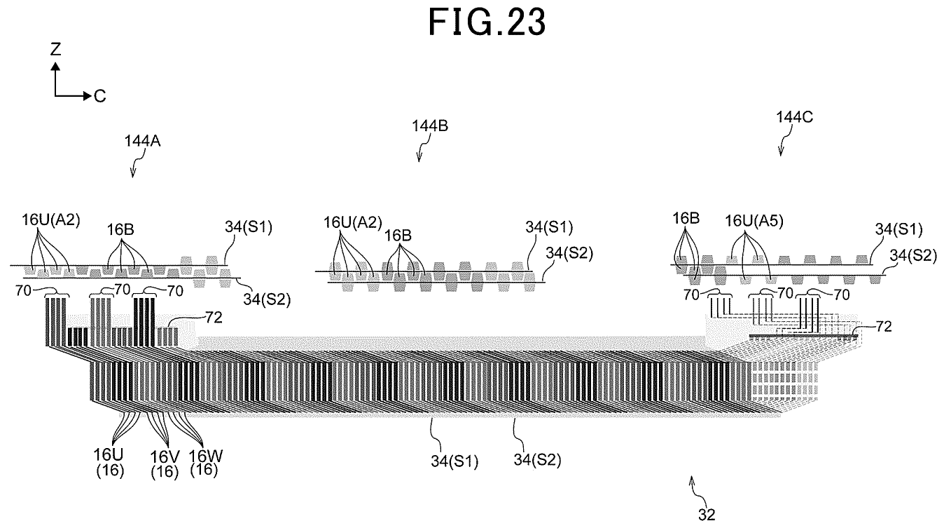

FIG. 23 shows the overlapped state (or laminated state) of the band member 34 (S1) of the first layer and the band member 34 (S2) of the second layer both of which are shown in FIG. 22. As shown in FIG. 23, in the overlapped state of the band member 34 (S1) of the first layer and the band member 34 (S2) of the second layer, the portions of the coil units 16 (i.e., the electrical conductor portions 16B) formed on the band member 34 (S1) of the first layer and the portions of the coil units 16 (i.e., the electrical conductor portions 16B) formed on the band member 34 (S2) of the second layer are arranged alternately along the circumferential direction. Moreover, in the overlapped state of the band member 34 (S1) of the first layer and the band member 34 (S2) of the second layer, the electrical conductor portions 16B formed on the band member 34 (S1) of the first layer and the electrical conductor portions 16B formed on the band member 34 (S2) of the second layer overlap one another in the circumferential direction. Consequently, it becomes possible to improve the space factor of the coil assembly 32 of the motor according to the present embodiment.

### Third Embodiment

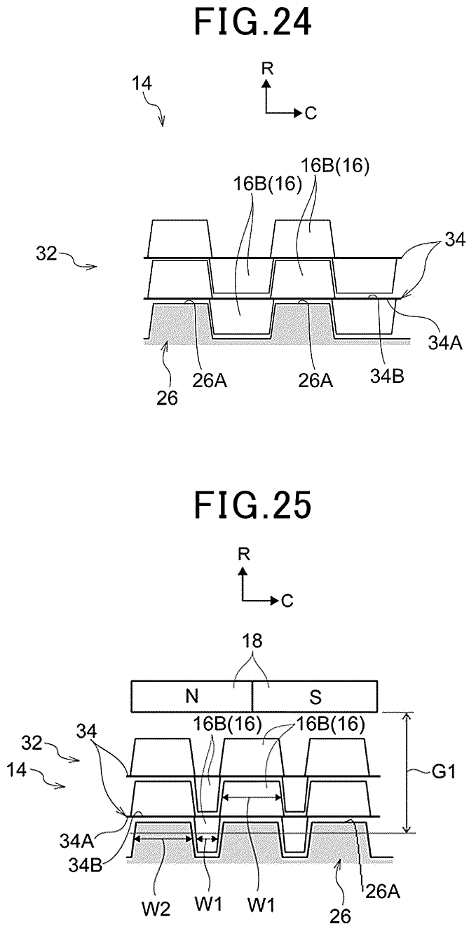

A motor according to the third embodiment will be described with reference to FIG. 24. It should be noted that: members and parts of the motor according to the third embodiment corresponding to those of the motor 10 and the like described above are designated by the same reference signs as the corresponding members and parts of the motor 10 and the like; and description of these parts and members will be omitted hereinafter.

FIG. 24 is a schematic cross-sectional view, taken along the radial direction, of the stator 14 of the motor according to the third embodiment. As shown in this figure, in the present embodiment, the coil assembly 32 that constitutes a part of the stator 14 has the same configuration as the coil assembly 32 of the motor according to the first embodiment described above.

In the stator 14 of the motor according to the present embodiment, of the electrical conductor portions 16B formed on the band member 34 of the layer opposed to the stator core 26, those electrical conductor portions 16B which face the stator core 26 are recess-protrusion-fitted to the stator core 26. Specifically, in an outer peripheral part of the stator core 26, there are formed a plurality of fitting protrusions 26A that protrude radially outward. Each of the fitting protrusions 26A is fitted into a recess formed between a corresponding pair of the electrical conductor portions 16B formed on the band member 34 of the layer opposed to the stator core 26. With the above configuration, the coil assembly 32 can be fixed to the stator core 26. Moreover, the fitting protrusions 26A can function as teeth. It should be noted that: teeth are portions of a stator core; and in a configuration in which a coil is formed by winding an electroconductive wire, the coil is formed around the teeth of the stator core. In the stator 14 of the motor according to the present embodiment, of the electrical conductor portions 16B formed on the band member 34 of the layer opposed to the stator core 26, those electrical conductor portions 16B which face the stator core 26 are inserted into the outer peripheral part of the stator core 26, thereby suppressing increase in the distance from an outer peripheral surface of the stator core 26 to a radially outer surface of the coil assembly 32.

### Fourth Embodiment

A motor according to the fourth embodiment will be described with reference to FIG. 25. It should be noted that: members and parts of the motor according to the fourth embodiment corresponding to those of the motor 10 and the like described above are designated by the same reference signs as the corresponding members and parts of the motor 10 and the like; and description of these parts and members will be omitted hereinafter.

FIG. 25 is a schematic cross-sectional view, taken along the radial direction, of the stator 14 of the motor according to the fourth embodiment. As shown in this figure, the configuration of the stator 14 of the motor according to the present embodiment is the same as that of the stator 14 of the motor according to the third embodiment, except for the points to be described later.

In the coil assembly 32 of the motor according to the fourth embodiment, of the electrical conductor portions 16B formed on the band member 34 of the layer opposed to the stator core 26, each of those electrical conductor portions 16B which are recess-protrusion-fitted to the stator core 26 has a circumferential width W1 set to be less than that of each of those electrical conductor portions 16B which are not recess-protrusion-fitted to the stator core 26. More particularly, in the present embodiment, of the electrical conductor portions 16B formed on each of the band members 34, the circumferential width dimension W1 of each of those electrical conductor portions 16B which are formed on the stator-core-26-side surface of the band member 34 is set to be less than the circumferential width dimension W1 of each of those electrical conductor portions 16B which are formed on the anti-stator-core-26-side surface of the band member 34. Moreover, in the present embodiment, the circumferential width W2 of each of the fitting protrusions 26A is set to be greater than the circumferential width of each of the fitting protrusions 26A of the motor according to the third embodiment described above. Furthermore, in the present embodiment, the circumferential width W1 of each of those electrical conductor portions 16B which are recess-protrusion-fitted to the stator core 26 is set to be less than the circumferential width W2 of each of the fitting protrusions 26A. With the above configuration, in the stator 14 of the motor according to the fourth embodiment, it becomes possible to shorten the magnetic gap G1 between the magnets 18 and the stator core 26 in comparison with the stator 14 of the motor according to the third embodiment. Consequently, it becomes possible to improve the output of the motor.

### Fifth Embodiment

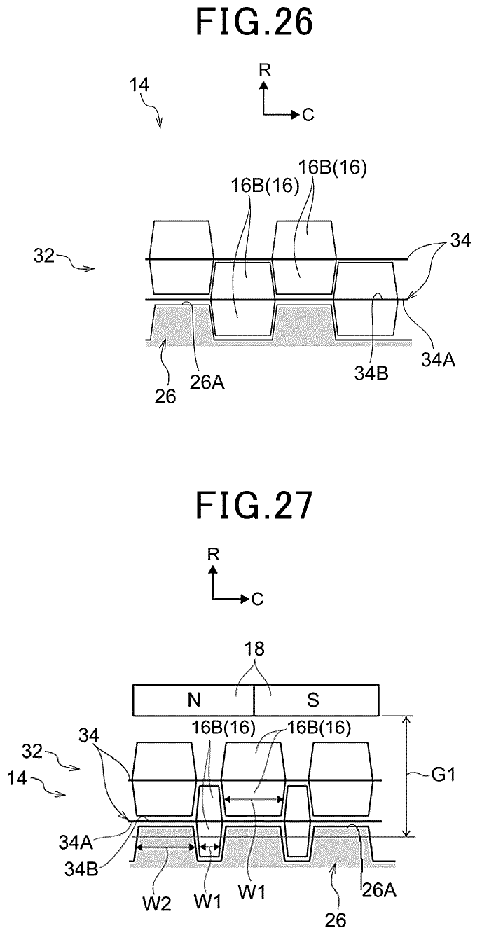

A motor according to the fifth embodiment will be described with reference to FIG. 26. It should be noted that: members and parts of the motor according to the fifth embodiment corresponding to those of the motor 10 and the like described above are designated by the same reference signs as the corresponding members and parts of the motor 10 and the like; and description of these parts and members will be omitted hereinafter.

FIG. 26 is a schematic cross-sectional view, taken along the radial direction, of the stator 14 of the motor according to the fifth embodiment. As shown in this figure, in the present embodiment, the coil assembly 32 that constitutes a part of the stator 14 has the same configuration as the coil assembly 32 of the motor according to the second embodiment described above. Moreover, in the present embodiment, the stator core 26 that constitutes another part of the stator 14 has the same configuration as the stator core 26 of the motor according to the third embodiment described above.

In the stator 14 of the motor according to the fifth embodiment, it is possible to achieve the same effects as achievable in the stator 14 of the motor according to the third embodiment.

### Sixth Embodiment

A motor according to the sixth embodiment will be described with reference to FIG. 27. It should be noted that: members and parts of the motor according to the sixth embodiment corresponding to those of the motor 10 and the like described above are designated by the same reference signs as the corresponding members and parts of the motor 10 and the like; and description of these parts and members will be omitted hereinafter.

FIG. 27 is a schematic cross-sectional view, taken along the radial direction, of the stator 14 of the motor according to the sixth embodiment. As shown in this figure, in the present embodiment, in the coil assembly 32 that constitutes a part of the stator 14, the circumferential width dimension W1 of each of the electrical conductor portions 16B formed on that one of the band members 34 which is located closest to the stator core 26 is set to be less than the circumferential width dimension W1 of each of the electrical conductor portions 16B formed on the remainder of the band members 34. Moreover, in the present embodiment, the stator core 26 that constitutes another part of the stator 14 has the same configuration as the stator core 26 of the motor according to the fourth embodiment described above.

In the stator 14 of the motor according to the sixth embodiment, it is possible to achieve the same effects as achievable in the stator 14 of the motor according to the fourth embodiment.

### Seventh Embodiment

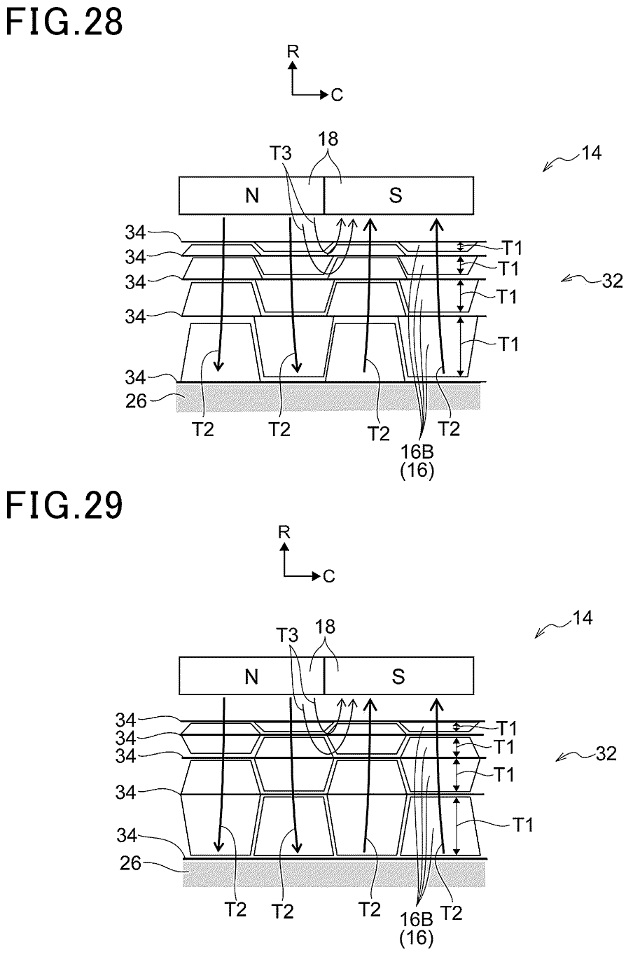

A motor according to the seventh embodiment will be described with reference to FIG. 28. It should be noted that: members and parts of the motor according to the seventh embodiment corresponding to those of the motor 10 and the like described above are designated by the same reference signs as the corresponding members and parts of the motor 10 and the like; and description of these parts and members will be omitted hereinafter.

FIG. 28 is a schematic cross-sectional view, taken along the radial direction, of the stator 14 of the motor according to the seventh embodiment. As shown in this figure, in the present embodiment, the coil assembly 32 that constitutes a part of the stator 14 has the same configuration as the coil assembly 32 of the motor according to the first embodiment described above, except for the points to be described later.

In the coil assembly 32 of the motor according to the present embodiment, for each radially-adjacent pair of the layers, the thickness T1 of each of the electrical conductor portions 16B formed on the band member 34 of one of the pair of the layers which is located closer to the magnets 18 is set to be less than the thickness T1 of each of the electrical conductor portions 16B formed on the band member 34 of the other of the pair of the layers which is located further from the magnets 18. It should be noted that the thicknesses T1 of the electrical conductor portions 16B denote the dimensions of the electrical conductor portions 16B in the direction (i.e., radial direction) in which the coil assembly 32 and the magnets 18 face each other.

Specifically, in the coil assembly 32 of the motor according to the present embodiment, five band members 34 are laminated in layers in the radial direction. Hereinafter, the five band members 34 will be sequentially referred to as the band member 34 of the first layer, the band member 34 of the second layer, the band member 34 of the third layer, the band member 34 of the fourth layer and the band member 34 of the fifth layer from the stator core 26 side to the magnets 18 side.

The thickness T1 of each of the electrical conductor portions 16B located between the band member 34 of the second layer and the band member 34 of the third layer is set to be less than the thickness T1 of each of the electrical conductor portions 16B located between the band member 34 of the first layer and the band member 34 of the second layer. Moreover, the thickness T1 of each of the electrical conductor portions 16B located between the band member 34 of the third layer and the band member 34 of the fourth layer is set to be less than the thickness T1 of each of the electrical conductor portions 16B located between the band member 34 of the second layer and the band member 34 of the third layer. Furthermore, the thickness T1 of each of the electrical conductor portions 16B located between the band member 34 of the fourth layer and the band member 34 of the fifth layer is set to be less than the thickness T1 of each of the electrical conductor portions 16B located between the band member 34 of the third layer and the band member 34 of the fourth layer. It should be noted that in FIG. 28, the arrows T2 designate magnetic flux radially crossing the coil assembly 32 whereas the arrows T3 designate leakage magnetic flux. By setting the thicknesses T1 of the electrical conductor portions 16B formed on the band members 34 to decrease toward the magnets 18 side where the leakage magnetic flux T3 circumferentially crosses the coil unit 32, it becomes possible to reduce the so-called eddy current loss. Moreover, by setting the thicknesses T1 of the electrical conductor portions 16B formed on the band members 34 to increase toward the stator core 26 side where the amount of the circumferentially-crossing magnetic flux is smaller, it becomes possible to reduce the so-called DC loss.

### Eighth Embodiment

A motor according to the eighth embodiment will be described with reference to FIG. 29. It should be noted that: members and parts of the motor according to the eighth embodiment corresponding to those of the motor 10 and the like described above are designated by the same reference signs as the corresponding members and parts of the motor 10 and the like; and description of these parts and members will be omitted hereinafter.

FIG. 29 is a schematic cross-sectional view, taken along the radial direction, of the stator 14 of the motor according to the eighth embodiment. As shown in this figure, in the present embodiment, the coil assembly 32 that constitutes a part of the stator 14 has the same basic configuration as the coil assembly 32 of the motor according to the second embodiment described above. Moreover, in the coil assembly 32 of the motor according to the present embodiment, the thicknesses T1 of the electrical conductor portions 16B formed on the band members 34 are set in the same manner as in the coil assembly 32 of the motor according to the seventh embodiment described above.

With the coil assembly 32 of the motor according to the present embodiment, it is possible to achieve the same effects as achievable with the coil assembly 32 of the motor according to the seventh embodiment.

### Ninth Embodiment

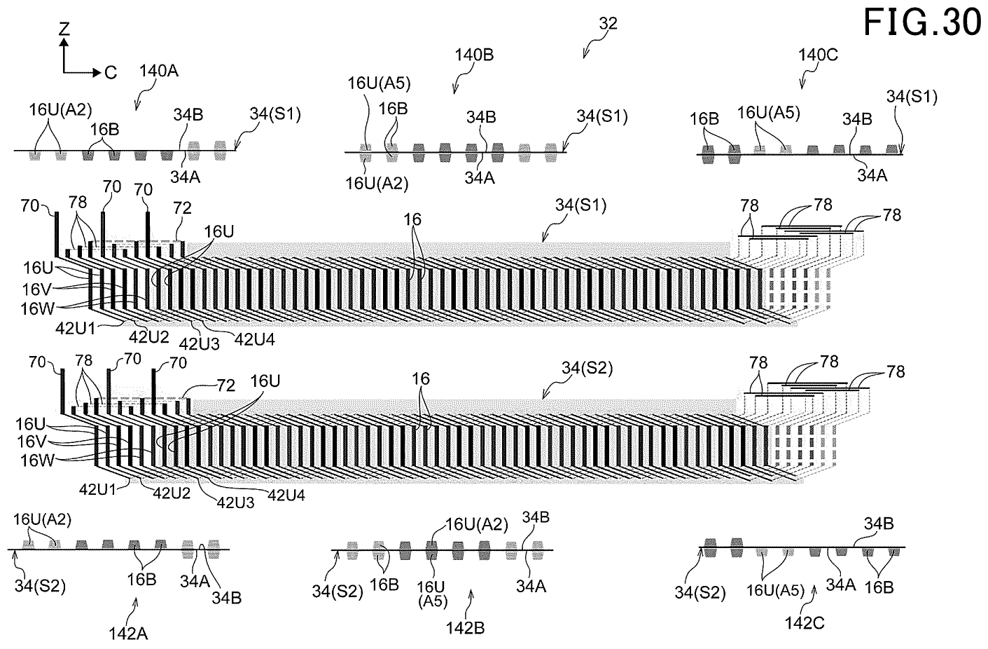

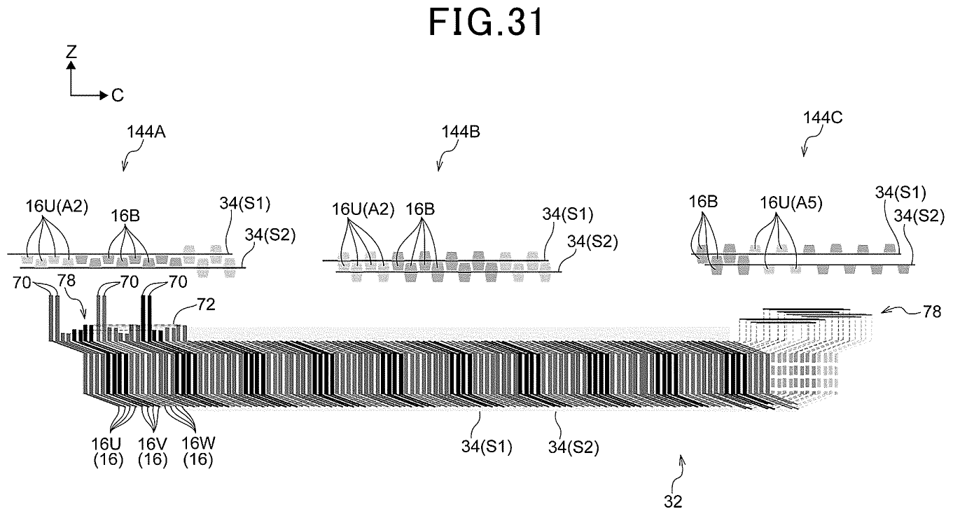

A motor according to the ninth embodiment will be described with reference to FIGS. 30 and 31. It should be noted that: members and parts of the motor according to the ninth embodiment corresponding to those of the motor 10 and the like described above are designated by the same reference signs as the corresponding members and parts of the motor 10 and the like; and description of these parts and members will be omitted hereinafter.

FIGS. 30 and 31 are diagrams for explaining the configuration of the coil assembly 32 of the motor according to the ninth embodiment, and correspond respectively to FIGS. 22 and 23 used for the explanation of the motor according to the second embodiment. As shown in these figures, the configuration of the coil assembly 32 of the motor according to the ninth embodiment is the same as that of the coil assembly 32 of the motor according to the second embodiment, except for the points to be described later.

As shown in FIG. 30, in the coil assembly 32 of the motor according to the present embodiment, the first U-phase coil group 42U1 and the fourth U-phase coil group 42U4 are connected in series with each other via a turnback conductor pattern 78. Moreover, the second U-phase coil group 42U2 and the third U-phase coil group 42U3 are also connected in series with each other via a turnback conductor pattern 78.

With the coil assembly 32 of the motor according to the present embodiment, it is possible to achieve the same effects as achievable with the coil assembly 32 of the motor according to the second embodiment. Moreover, with the coil assembly 32 of the motor according to the present embodiment, it is possible to further achieve the effect of increasing the number of turns compared to the coil assembly 32 of the motor according to the second embodiment. It should be noted that the number of turns here denotes the number of turns of a coil formed by winding an electroconductive wire.

### Tenth and Eleventh Embodiments

Motors according to the tenth and eleventh embodiments will be described with reference to FIGS. 32 and 33. It should be noted that: members and parts of the motors according to the tenth and eleventh embodiments corresponding to those of the motor 10 and the like described above are designated by the same reference signs as the corresponding members and parts of the motor 10 and the like; and description of these parts and members will be omitted hereinafter.

As shown in FIG. 32, in the coil assembly 32 of the motor according to the tenth embodiment, the end part 34D of the band member 34 on the first side in the circumferential direction and the end part 34C of the band member 34 on the second side in the circumferential direction are overlapped with each other so that each of the input lines 70 arranged on the end part 34D of the band member 34 on the first side in the circumferential direction is connected to a corresponding one of the input lines 70 arranged on the end part 34C of the band member 34 on the second side in the circumferential direction. This configuration can be applied to, for example, the coil assembly 32 of the motor according to the second embodiment.

As shown in FIG. 33, in the coil assembly 32 of the motor according to the eleventh embodiment, the end part 34D of the band member 34 on the first side in the circumferential direction and the end part 34C of the band member 34 on the second side in the circumferential direction are overlapped with each other so that each of the input lines 70 arranged on the end part 34D of the band member 34 on the first side in the circumferential direction is connected to a corresponding one of the input lines 70 arranged on the end part 34C of the band member 34 on the second side in the circumferential direction. This configuration can be applied to, for example, the coil assembly 32 of the motor according to the first embodiment.

### Example of Method of Manufacturing Coil Assembly 32

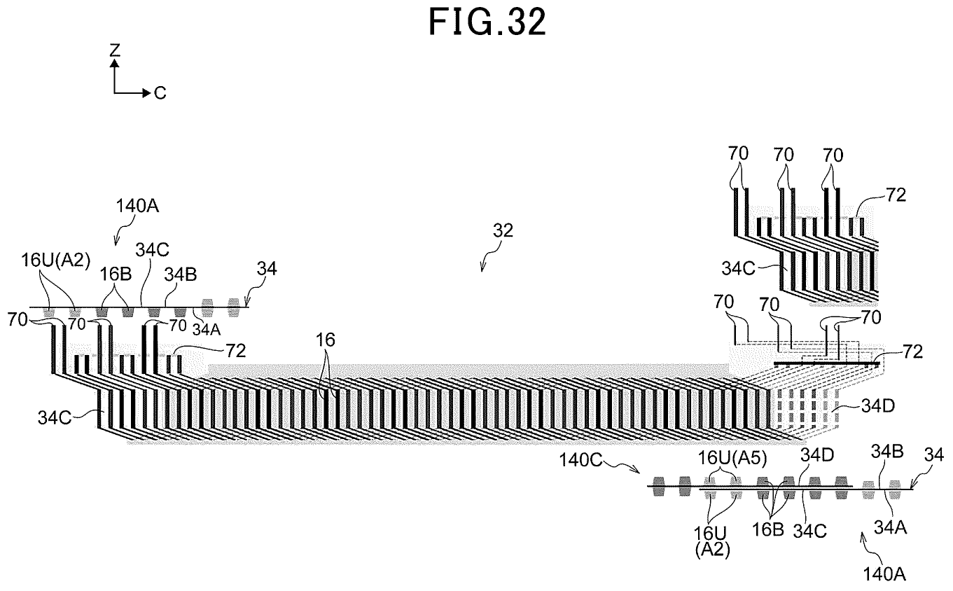

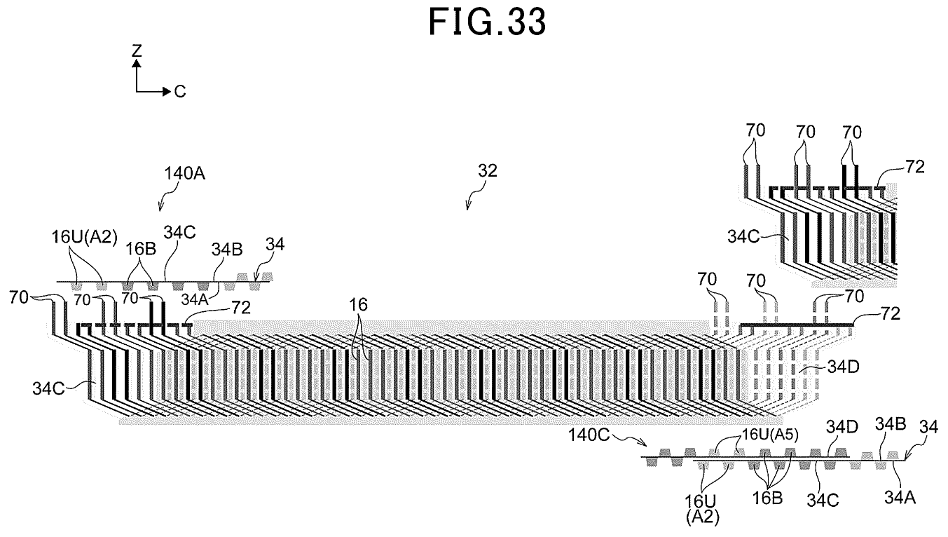

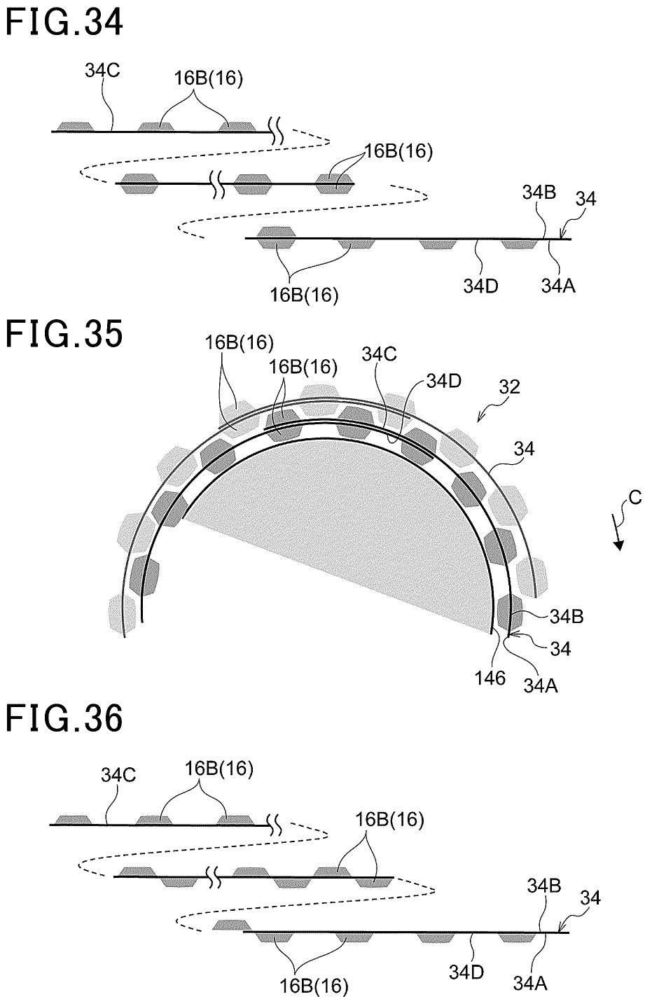

Next, an example of a method of manufacturing a coil assembly 32 will be described with reference to FIGS. 34 to 39.

FIG. 34 shows a cross section of a band member 34 of a first layer before being rolled into an annular shape and coil units 16 formed on the band member 34. It should be noted that the configurations of the band member 34 of the first layer and the coil units 16 formed on the band member 34 shown in FIG. 34 are the same as those of the band members 34 and the coil units 16 formed on the band members 34 in the motor according to the second embodiment. In this example, the band member 34 is rolled into an annular shape from an end part 34D thereof on the first side in the circumferential direction. Specifically, as shown in FIG. 35, the band member 34 of the first layer is rolled, from the end part 34D thereof on the first side in the circumferential direction, around a rolling mandrel 146 into an annular shape; the rolling mandrel 146 is a die. Then, the end part 34D of the band member 34 of the first layer on the first side in the circumferential direction and an end part 34C of the band member 34 of the first layer on the second side in the circumferential direction are overlapped with and joined to each other, so that the band member 34 of the first layer is kept in the annularly-rolled state. Thereafter, in the same manner as described above, a band member 34 of a second layer is rolled around the band member 34 of the first layer into an annular shape.

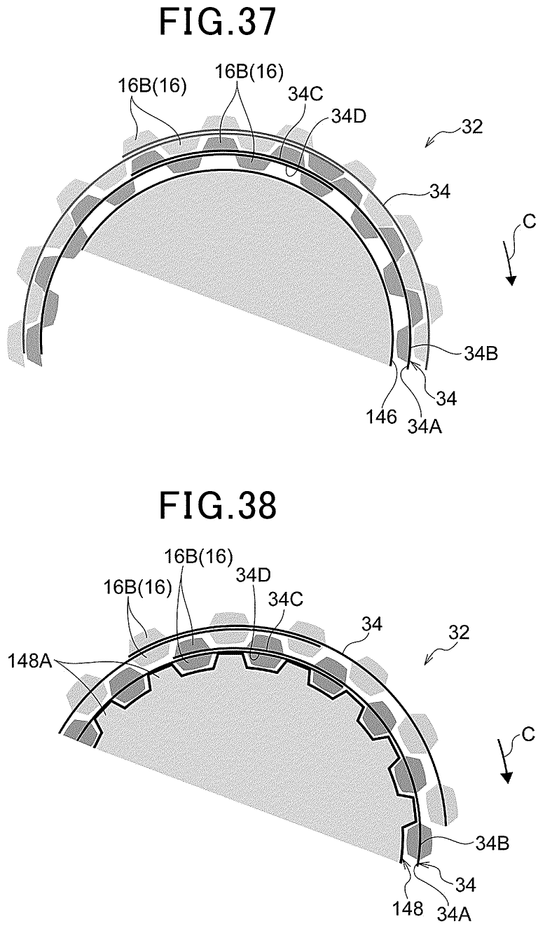

FIG. 36 shows a cross section of a band member 34 of a first layer before being rolled into an annular shape and coil units 16 formed on the band member 34. It should be noted that the configurations of the band member 34 of the first layer and the coil units 16 formed on the band member 34 shown in FIG. 36 are the same as those of the band members 34 and the coil units 16 formed on the band members 34 in the motor according to the first embodiment. As shown in FIG. 37, the band member 34 of the first layer is rolled, from and end part 34D thereof on the first side in the circumferential direction, around the rolling mandrel 146 into an annular shape. Then, the end part 34D of the band member 34 of the first layer on the first side in the circumferential direction and an end part 34C of the band member 34 of the first layer on the second side in the circumferential direction are overlapped with and joined to each other, so that the band member 34 of the first layer is kept in the annularly-rolled state. Thereafter, in the same manner as described above, a band member 34 of a second layer is rolled around the band member 34 of the first layer into an annular shape.

FIG. 38 shows a rolling mandrel 148 having a different configuration from the rolling mandrel 146 shown in FIGS. 35 and 37. In an outer peripheral part of the rolling mandrel 148, there are formed a plurality of rolling fitting protrusions 148A that protrude radially outward. In the case of employing the rolling mandrel 148, a band member 34 of a first layer can be rolled around the rolling mandrel 148 while the rolling fitting protrusions 148A are fitted respectively into recesses formed between the electrical conductor portions 16B formed on the band member 34 of the first layer. Consequently, it becomes possible to suppress circumferential displacement of the band member 34 of the first layer relative to the rolling mandrel 148 during the rolling of the band member 34 of the first layer around the rolling mandrel 148.

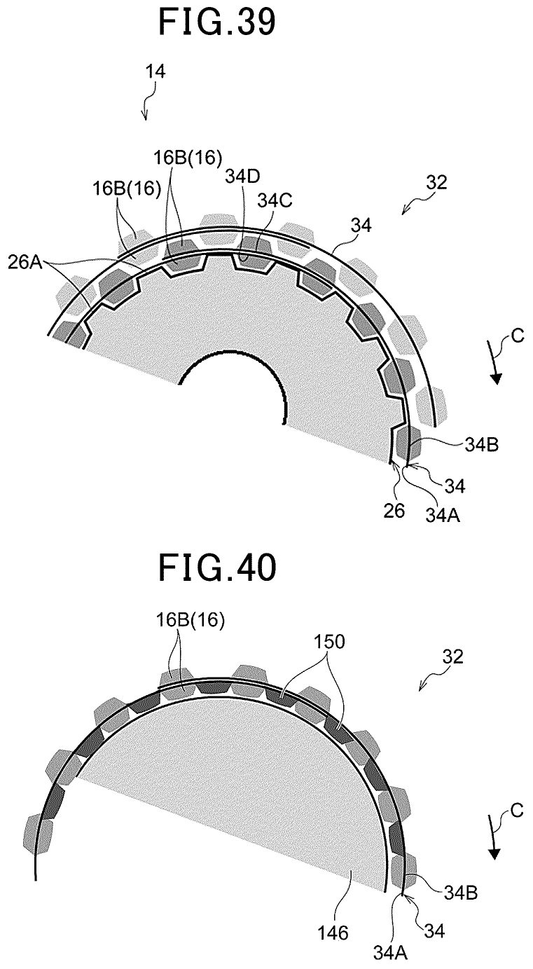

FIG. 39 shows a stator core 26 having the same configuration as the stator core 26 of the motor according to the third embodiment. In the case of employing this stator core 26, a band member 34 of a first layer can be rolled around the stator core 26 while fitting protrusions 26A of the stator core 26 are fitted respectively into recesses formed between the electrical conductor portions 16B formed on the band member 34 of the first layer. Consequently, it becomes possible to suppress circumferential displacement of the band member 34 of the first layer relative to the stator core 26 during the rolling of the band member 34 of the first layer around the stator core 26.

### Twelfth to Fifteenth Embodiments

A motor according to the twelfth embodiment will be described with reference to FIG. 40. It should be noted that: members and parts of the motor according to the twelfth embodiment corresponding to those of the motor 10 and the like described above are designated by the same reference signs as the corresponding members and parts of the motor 10 and the like; and description of these parts and members will be omitted hereinafter.

FIG. 40 shows a coil assembly 32 of the motor according to the twelfth embodiment. In the coil assembly 32 of the motor according to the present embodiment, a plurality of soft-magnetic portions 150 are formed on a band member 34. The soft-magnetic portions 150 are formed of a soft-magnetic material and arranged in alignment with one another in the circumferential direction. In the coil assembly 32 of the motor according to the present embodiment, the soft-magnetic portions 150 are formed only on that surface of the band member 34 which faces the stator core 26. Moreover, each of the soft-magnetic portions 150 is arranged between a circumferentially-adjacent pair of electrical conductor portions 16B formed on the band member 34. With the above configuration, the soft-magnetic portions 150 can function as teeth, similar to the fitting protrusions 26A (see FIG. 24) described above.

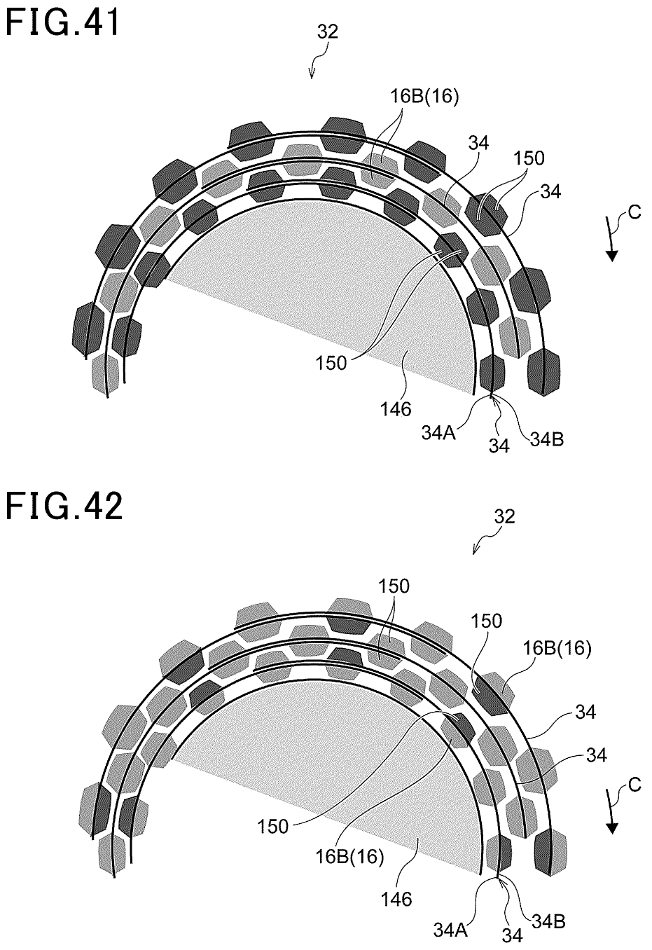

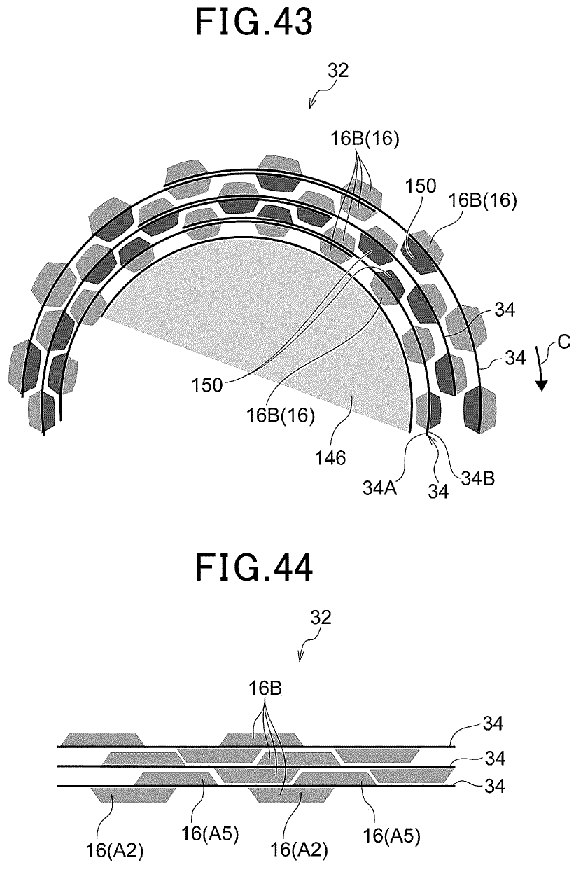

The arrangement of the soft-magnetic portions 150 may be suitably set in consideration of the characteristics required of the motor. For example, as in a coil assembly 32 of a motor according to the thirteenth embodiment shown in FIG. 41, only soft-magnetic portions 150 may be formed on a band member 34 of a first layer and a band member 34 of a third layer. Alternatively, as in a coil assembly 32 of a motor according to the fourteenth embodiment shown in FIG. 42, both soft-magnetic portions 150 and electrical conductor portions 16B may be formed on a band member 34 of a first layer and a band member 34 of a third layer. Moreover, as in a coil assembly 32 of a motor according to the fifteenth embodiment shown in FIG. 43, both soft-magnetic portions 150 and electrical conductor portions 16B may be formed on band members 34 of all layers.

### Sixteenth Embodiment

A motor according to the sixteenth embodiment will be described with reference to FIG. 44. It should be noted that: members and parts of the motor according to the sixteenth embodiment corresponding to those of the motor 10 and the like described above are designated by the same reference signs as the corresponding members and parts of the motor 10 and the like; and description of these parts and members will be omitted hereinafter.

FIG. 44 is a schematic diagram showing a cross section, taken along the radial direction, of a coil assembly 32 of the motor according to the sixteenth embodiment. As shown in this figure, in the coil assembly 32 of the motor according to the present embodiment, the circumferential offset distance between the second straight portion A2 of one coil unit 16 and the fifth straight portion A5 of another coil unit 16 is set to be in an intermediate range between the setting of the coil assembly 32 of the motor according to the first embodiment and the setting of the coil assembly 32 of the motor according to the second embodiment. With this configuration, it is also possible to improve the space factor of the coil assembly 32.

### Seventeenth Embodiment

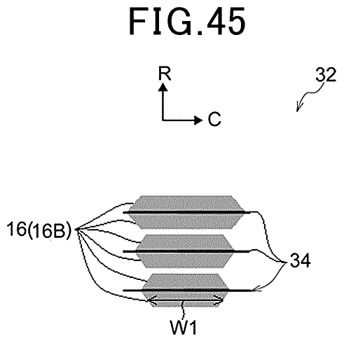

A motor according to the seventeenth embodiment will be described with reference to FIG. 45. It should be noted that: members and parts of the motor according to the seventeenth embodiment corresponding to those of the motor 10 and the like described above are designated by the same reference signs as the corresponding members and parts of the motor 10 and the like; and description of these parts and members will be omitted hereinafter.

FIG. 45 is a schematic diagram showing a cross section, taken along the radial direction, of a coil assembly 32 of the motor according to the seventeenth embodiment. As shown in this figure, in the coil assembly 32 of the motor according to the present embodiment, the circumferential widths (W1) of electrical conductor portions 16B gradually increase from a band member 34 of a first layer to band members 34 of the other layers which are located radially outside the band member 34 of the first layer. With the above configuration, it becomes possible to have the cross-sectional areas of the electrical conductor portions 16B gradually increasing in a radially outward direction, thereby improving the space factor of the coil units 16.

While the above embodiments of the present disclosure have been described, it will be understood by those skilled in the art that the present disclosure is not limited to the above embodiments, but may be carried out through various modifications without departing from the spirit of the present disclosure. Moreover, all or some of the configurations of the motors according to the above embodiments may be combined with each other.

For example, the configurations of the motor 10 and the like may be suitably selected depending on the applications of the motor 10 and the like. Moreover, the configurations of the motor 10 and the like can also be applied to electric generators. Furthermore, the configurations of the motor 10 and the like can also be applied to outer rotor type brushless motors in which a rotor 12 is arranged radially outside a stator 14. In addition, the configurations of the coil assemblies 32 according to the present disclosure can also be applied to coil assemblies 32 included in rotors. cl Notes

### (First Note)

A coil assembly (32) comprising:
sheet-shaped members (34) formed of an electrically-insulative material into a sheet shape extending in a circumferential direction, the sheet-shaped members being laminated in layers in a radial direction; and
a plurality of coil units (16) formed of an electroconductive material on each of the sheet-shaped members and having a plurality of electrical conductor portions (16B) arranged in alignment with one another along the circumferential direction,
wherein
the electrical conductor portions formed on the sheet-shaped member of a first layer and the electrical conductor portions formed on the sheet-shaped member of a second layer are arranged alternately along the circumferential direction, and
the electrical conductor portions formed on the sheet-shaped member of the first layer and the electrical conductor portions formed on the sheet-shaped member of the second layer overlap one another in the circumferential direction.

### (Second Note)

The coil assembly according to the first note, wherein
the first layer and the second layer are adjacent to each other in the radial direction, and
a pattern of the coil units formed on the sheet-shaped member of the first layer matches a pattern of the coil units formed on the sheet-shaped member of the second layer.

### (Third Note)

The coil assembly according to the first note or the second note, wherein
the first layer and the second layer are adjacent to each other in the radial direction,
a circumferential width (W1) of each of the electrical conductor portions formed on the sheet-shaped member of the first layer gradually decreases toward the sheet-shaped member of the second layer, and
a circumferential width of each of the electrical conductor portions formed on the sheet-shaped member of the second layer gradually decreases toward the sheet-shaped member of the first layer.

### (Fourth Note)

The coil assembly according to any one of the first to third notes, further comprising a plurality of magnetic portions (150) formed of a soft-magnetic material on each of the sheet-shaped members and arranged in alignment with one another along the circumferential direction.

### (Fifth Note)

The coil assembly according to any one of the first to fourth notes, wherein
the sheet-shaped members comprise the sheet-shaped member of the first layer and the sheet-shaped members of the other layers which are located radially outside the sheet-shaped member of the first layer, and
circumferential widths (W1) of the electrical conductor portions gradually increase from the sheet-shaped member of the first layer to the sheet-shaped members of the other layers.

### (Sixth Note)

An armature (14) comprising the coil assembly according to any one of the first to fifth notes.

### (Seventh Note)

The armature according to the sixth note, further comprising an armature core (26) formed of a soft-magnetic material into an annular shape, wherein
the coil assembly is arranged along the armature core, and
the electrical conductor portions formed on the sheet-shaped member of one of the layers which is opposed to the armature core are recess-protrusion-fitted to the armature core.

### (Eighth Note)

An armature (14) comprising:
the coil assembly according to any one of the first, third, fourth and fifth notes; and
an armature core (26) formed of a soft-magnetic material into an annular shape,
wherein
the coil assembly is arranged along the armature core,
the electrical conductor portions formed on the sheet-shaped member of one of the layers which is opposed to the armature core are recess-protrusion-fitted to protrusions formed in the armature core, and
a circumferential width of each of the electrical conductor portions facing and recess-protrusion-fitted to the armature core is set to be less than a circumferential width of each of the protrusions of the armature core.

### (Ninth Note)

A rotating electric machine (10) comprising:
a stator (14); and
a rotor (12),
wherein
one of the stator and the rotor includes the armature according to the sixth note, and the other of the stator and the rotor has a magnet (18) arranged to face the coil assembly in the radial direction or in an axial direction.

### (Tenth Note)

The rotating electric machine according to the ninth note, wherein
for each of the electrical conductor portions, a dimension of the electrical conductor portion in the radial direction, in which the coil assembly and the magnet face each other, is defined as a thickness (T1) of the electrical conductor portion, and for each radially-adjacent pair of the layers, the thickness of each of the electrical conductor portions formed on the sheet-shaped member of one of the pair of the layers which is located closer to the magnet is set to be less than the thickness of each of the electrical conductor portions formed on the sheet-shaped member of the other of the pair of the layers which is located further from the magnet.

While the present disclosure has been described pursuant to the embodiments, it should be appreciated that the present disclosure is not limited to the embodiments and the structures. Instead, the present disclosure encompasses various modifications and changes within equivalent ranges. In addition, various combinations and modes are also included in the category and the scope of technical idea of the present disclosure.

What is claimed is:

1. A coil assembly comprising:
sheet-shaped members formed of an electrically-insulative material into a sheet shape extending in a circumferential direction, the sheet-shaped members being laminated in layers in a radial direction; and
a plurality of coil units formed of an electroconductive material on each of the sheet-shaped members and having a plurality of electrical conductor portions arranged in alignment with one another along the circumferential direction,
wherein
the electrical conductor portions formed on the sheet-shaped member of a first layer and the electrical conductor portions formed on the sheet-shaped member of a second layer are arranged alternately along the circumferential direction, and
the electrical conductor portions formed on the sheet-shaped member of the first layer and the electrical conductor portions formed on the sheet-shaped member of the second layer overlap one another in the circumferential direction.

2. The coil assembly as set forth in claim 1, wherein
the first layer and the second layer are adjacent to each other in the radial direction, and
a pattern of the coil units formed on the sheet-shaped member of the first layer matches a pattern of the coil units formed on the sheet-shaped member of the second layer.

3. The coil assembly as set forth in claim 1, wherein
the first layer and the second layer are adjacent to each other in the radial direction,
a circumferential width of each of the electrical conductor portions formed on the sheet-shaped member of the first layer gradually decreases toward the sheet-shaped member of the second layer, and
a circumferential width of each of the electrical conductor portions formed on the sheet-shaped member of the second layer gradually decreases toward the sheet-shaped member of the first layer.

4. The coil assembly as set forth in claim 1, further comprising a plurality of magnetic portions formed of a soft-magnetic material on each of the sheet-shaped members and arranged in alignment with one another along the circumferential direction.

5. The coil assembly as set forth in claim 1, wherein
the sheet-shaped members comprise the sheet-shaped member of the first layer and the sheet-shaped members of the other layers which are located radially outside the sheet-shaped member of the first layer, and
circumferential widths of the electrical conductor portions gradually increase from the sheet-shaped member of the first layer to the sheet-shaped members of the other layers.

6. An armature comprising the coil assembly as set forth in claim 1.

7. The armature as set forth in claim 6, further comprising an armature core formed of a soft-magnetic material into an annular shape, wherein
the coil assembly is arranged along the armature core, and
the electrical conductor portions formed on the sheet-shaped member of one of the layers which is opposed to the armature core are recess-protrusion-fitted to the armature core.

8. An armature comprising:
the coil assembly as set forth in claim 1; and
an armature core formed of a soft-magnetic material into an annular shape,
wherein
the coil assembly is arranged along the armature core,
the electrical conductor portions formed on the sheet-shaped member of one of the layers which is opposed to the armature core are recess-protrusion-fitted to protrusions formed in the armature core, and
a circumferential width of each of the electrical conductor portions facing and recess-protrusion-fitted to the armature core is set to be less than a circumferential width of each of the protrusions of the armature core.

9. A rotating electric machine comprising:
a stator; and
a rotor,
wherein
one of the stator and the rotor includes the armature as set forth in claim 6, and the other of the stator and the rotor has a magnet arranged to face the coil assembly in the radial direction or in an axial direction.

10. The rotating electric machine as set forth in claim 9, wherein
for each of the electrical conductor portions, a dimension of the electrical conductor portion in the radial direction, in which the coil assembly and the magnet face each other, is defined as a thickness of the electrical conductor portion, and
for each radially-adjacent pair of the layers, the thickness of each of the electrical conductor portions formed on the sheet-shaped member of one of the pair of the layers which is located closer to the magnet is set to be less than the thickness of each of the electrical conductor portions formed on the sheet-shaped member of the other of the pair of the layers which is located further from the magnet.
